(19) United States
(12) Patent Application Publication
(10) Pub. No.: US 2026/0141176 A1
(43) Pub. Date: May 21, 2026

(54) DEVICE FOR SPECULATIVE DECODING IN ELECTRONIC DEVICE AND OPERATION METHOD THEREOF

(71) Applicant: Samsung Electronics Co., Ltd., Suwon-si (KR)

(72) Inventors: Junhyuk LEE, Suwon-si (KR); Seungjin YANG, SSuwon-si (KR)

(21) Appl. No.: 19/448,618

(22) Filed: Jan. 14, 2026

Related U.S. Application Data
(63) Continuation of application No. PCT/KR2025/008429, filed on Jun. 18, 2025.

(30) Foreign Application Priority Data
Jun. 18, 2024 (KR) 10-2024-0079040
Aug. 13, 2024 (KR) 10-2024-0108628

(51) Int. Cl. G06F 40/284; G06F 40/40

(52) U.S. Cl. CPC G06F 40/284; G06F 40/40

(57) ABSTRACT

The disclosure relates to a device performing speculative decoding based on an AI model in an electronic device and an operation method thereof. The electronic device outputs first tokens for each draft model in response to an input of a prompt in a plurality of first models; outputs second tokens for each draft model using the first tokens for each draft model in a target model; and determines a target draft model to be used for speculative decoding among the plurality of first models based on a similarity between a first probability distribution of the first tokens for each draft model and a second probability distribution of the second tokens for each draft model.

### CROSS-REFERENCE TO RELATED APPLICATIONS

This application is a continuation of International Application No. PCT/KR2025/008429 designating the United States, filed on Jun. 18, 2025, in the Korean Ministry of Intellectual Property Receiving Office, and claiming priority from Korean Patent Application Nos. 10-2024-0079040 filed on Jun. 18, 2024, and 10-2024-0108628 filed on Aug. 13, 2024, in the Korean Ministry of Intellectual Property, the disclosures of each of which are incorporated by reference herein in their entireties.

### BACKGROUND

### Field

The disclosure relates to a device performing speculative decoding in an electronic device and an operation method thereof, for example, a device performing speculative decoding based on an artificial intelligence (AI) model and an operation method thereof.

### Description of Related Art

AI may refer to technology that artificially implements a human being's learning ability, inference ability, and perception ability. The AI is evolving into a generative AI that may produce text, images, or other media in response to the prompt corresponding to a user's input. The large language model (LLM) may be a representative example of a generative AI.

The AI is evolving from cloud-based AI, that was connected to external servers or clouds to receive data and operations, to on-device AI that is installed on the device itself to provide AI services. Devices to which the on-device AI may be applied may include devices based on a mobile environment, such as smartphones or tablet PCs. The on-device AI may process information on its own and thereby being free from Internet connection or communication state. However, the on-device AI has limitations such as difficulty in hardware extensions for the applied devices and thus requires a method for processing massive data based on limited computation capabilities and/or memory capacity.

The above-described information may be provided as related art for the purpose of helping to understand the disclosure. No assertion is made as to whether the foregoing constitutes or can be applied as prior art related to the disclosure.

### SUMMARY

According to an example embodiment of the disclosure, an electronic device may comprise: a memory including one or more storage media storing instructions; and at least one processor, comprising processing circuitry, wherein at least one processor, individually and/or collectively, is configured to execute the instructions and to cause the electronic device to perform at least one operation comprising: outputting first tokens for each first model in response to an input of a prompt in a plurality of first models; outputting second tokens for each first model using the first tokens for each first model in a second model; and determining a target model to be used for speculative decoding among the plurality of first models based on a similarity between a first probability distribution of the first tokens for each first model and a second probability distribution of the second tokens for each first model.

According to an example embodiment of the disclosure, there may be provided a non-transitory computer-readable storage medium storing at least one computer-readable instruction. The at least one instruction, when executed by at least one processor of an electronic device, individually and/or collectively, may cause the electronic device to perform at least one operation comprising: outputting first tokens for each first model in response to an input of a prompt in a plurality of first models; outputting second tokens for each first model using the first tokens for each first model in a second model; and determining a target model to be used for speculative decoding among the plurality of first models based on a similarity between a first probability distribution of the first tokens for each first model and a second probability distribution of the second tokens for each first model.

According to an example embodiment of the disclosure, there may be provided a method for performing by an electronic device. The method may comprise: outputting first tokens for each first model in response to an input of a prompt in a plurality of first models; outputting second tokens for each first model using the first tokens for each first model in a second model; and determining a target model to be used for speculative decoding among the plurality of first models based on a similarity between a first probability distribution of the first tokens for each first model and a second probability distribution of the second tokens for each first model.

According to an example embodiment of the disclosure, an electronic device may comprise at least one processor comprising processing circuitry. The electronic device may comprise a memory storing instructions. The instructions may, when executed individually and/or collectively by at least one processor, cause the electronic device to perform at least one operation, the operation comprising: an AI model including a target model, a first draft model and a second draft model having a smaller size than the target model; obtaining input tokens for the AI model based on an input; identifying first output tokens of the first draft model for the input tokens and first probabilities that the first output tokens, respectively, are to be output from the first draft model; identifying second output tokens of the target model for the first output tokens and second probabilities that the second output tokens, respectively, are to be output from the target model; identifying third output tokens of the second draft model for the input tokens and third probabilities that the third output tokens, respectively, are to be output from the second draft model; identifying fourth output tokens of the target model for the third output tokens and fourth probabilities that the fourth output tokens, respectively, are to be output from the target model; selecting one of the first draft model and the second draft model at least partially based on the first probabilities, the second probabilities, the third probabilities, and the fourth probabilities; and providing an output for the input at least partially based on the selected one draft model.

According to an example embodiment of the disclosure, an electronic device may comprise: a memory including one or more storage media storing instructions; at least one processor including processing circuitry. The instructions may, when executed individually and/or collectively by at least one processor, cause the electronic device to perform at least one operation comprising: inputting a prompt corresponding to an input to a target model and a plurality of draft models included in a generative AI model, wherein the target model may have a relatively large size as compared with the plurality of draft models, and the plurality of draft models may have different sizes; obtaining a specific number of sequential output tokens in response to an input of a start token based on the prompt from the plurality of draft models, wherein the start token may be input from the target model in response to the input of the prompt; verifying output tokens for each draft model obtained by the plurality of draft models from the target model; and determining a first draft model to be used among the plurality of draft models based on a result of the verification. First probability information about the first draft model may be similar to second probability information about the target model, relative to probability information about one or more other draft models. The first probability information may be determined by a first probability value which is a numerical value of a possibility (e.g., accuracy) that each of the first output tokens obtained from the first draft model matches information included in the prompt. The second probability information may be determined by a second probability value which is a numerical value of a possibility (e.g., accuracy) that each of the second output tokens obtained by the target model using the first output tokens as an input matches information included in the prompt. The second output tokens may be at least partially identical to the first output tokens.

According to an example embodiment of the disclosure, there may be provided a non-transitory computer-readable storage medium storing computer-readable instructions. The instructions may, when executed by at least some of at least one processor of an electronic device, cause the electronic device to perform at least one operation comprising: inputting a prompt corresponding to an input to a target model and a plurality of draft models included in a generative AI model, wherein the target model may have a relatively large size as compared with the plurality of draft models, and the plurality of draft models may have different sizes; obtaining a specific number of sequential output tokens in response to an input of a start token based on the prompt from the plurality of draft models, wherein the start token may be input from the target model in response to the input of the prompt; verifying output tokens for each draft model obtained by the plurality of draft models from the target model; and determining a first draft model to be used among the plurality of draft models based on a result of the verification. First probability information about the first draft model may be similar to second probability information about the target model, relative to probability information about one or more other draft models. The first probability information may be determined by a first probability value which is a numerical value of a possibility (e.g., accuracy) that each of the first output tokens obtained from the first draft model matches information included in the prompt. The second probability information may be determined by a second probability value which is a numerical value of a possibility (e.g., accuracy) that each of the second output tokens obtained by the target model using the first output tokens as an input matches information included in the prompt. The second output tokens may be at least partially identical to the first output tokens.

According to an example embodiment of the disclosure, there may be provided a method for executing a generative AI model in an electronic device. The method may comprise: inputting a prompt corresponding to an input to a target model and a plurality of draft models included in an AI model, wherein the target model may have a relatively large size as compared with the plurality of draft models, and the plurality of draft models may have different sizes; obtaining a specific number of sequential first output tokens in response to an input of a start token based on the prompt from the plurality of draft models, wherein the start token may be input from the target model in response to the input of the prompt; identifying first probability information which is a numerical value of a possibility (e.g., accuracy) that each of the first output tokens obtained for each draft model from the plurality of draft models matches information included in the prompt; obtaining second output tokens for each draft model using the first output tokens as an input from the target model; identifying second probability information which is a numerical value of a possibility (e.g., accuracy) that each of the second output tokens obtained for each draft model from the target model matches information included in the prompt; and determining a draft model in which the first probability information is similar to the second probability information relative to one or more other draft models, among the plurality of draft models, as a first draft model, wherein the second output tokens may be at least partially similar to the first output tokens.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a block diagram illustrating an example configuration of an electronic device capable of performing operations according to one or more embodiment(s);

FIG. 2 is a block diagram illustrating an example configuration of an AI model to operate in an electronic device according to one or more embodiment(s);

FIG. 3 is a block diagram illustrating an example large language model equipped in an electronic device according to one or more embodiment(s);

FIG. 4 is a diagram illustrating an example operation of configuring an large language model for speculative decoding in an electronic device according to one or more embodiment(s);

FIG. 5 is a diagram illustrating an example operation of failing to be determined as a preferred draft model as a specific draft model included in a plurality of draft models to be paired with a target model in an electronic device equipped with an AI model based on speculative decoding according to one or more embodiment(s);

FIG. 6 is a diagram illustrating an example operation of determining a preferred draft model to be paired with a target model in a draft model group in an electronic device equipped with an AI model based on speculative decoding according to one or more embodiment(s);

FIG. 7 is an diagram illustrating an example operation of generating tokens based on speculative decoding with a preferred draft model determined from a plurality of draft models and a target model paired in an electronic device according to one or more embodiment(s);

FIG. 8 is an diagram illustrating an example operation of generating tokens based on speculative decoding in an electronic device according to one or more embodiment(s);

FIG. 9 is a flowchart illustrating example operations for performing speculative decoding in an electronic device according to one or more embodiment(s);

FIG. 10 is a flowchart illustrating example operations for driving a generative AI model in an electronic device according to one or more embodiment(s);

FIG. 11 is a diagram illustrating an example configuration for driving a generative AI model in an electronic device according to one or more embodiment(s);

FIG. 12 is a block diagram illustrating an example electronic device in a network environment according to one or more embodiment(s); and

FIG. 13 is a block diagram illustrating an example AI system capable of performing operations according to one or more embodiment(s).

### DETAILED DESCRIPTION

Hereinafter, various example embodiments of the disclosure are described in greater detail with reference to the drawings. However, the disclosure may be implemented in other various forms and is not limited to the various embodiments set forth herein. The same or similar reference denotations may be used to refer to the same or similar elements throughout the disclosure and the drawings. Further, for clarity and brevity, descriptions of well-known functions and configurations in the drawings and relevant descriptions may be omitted.

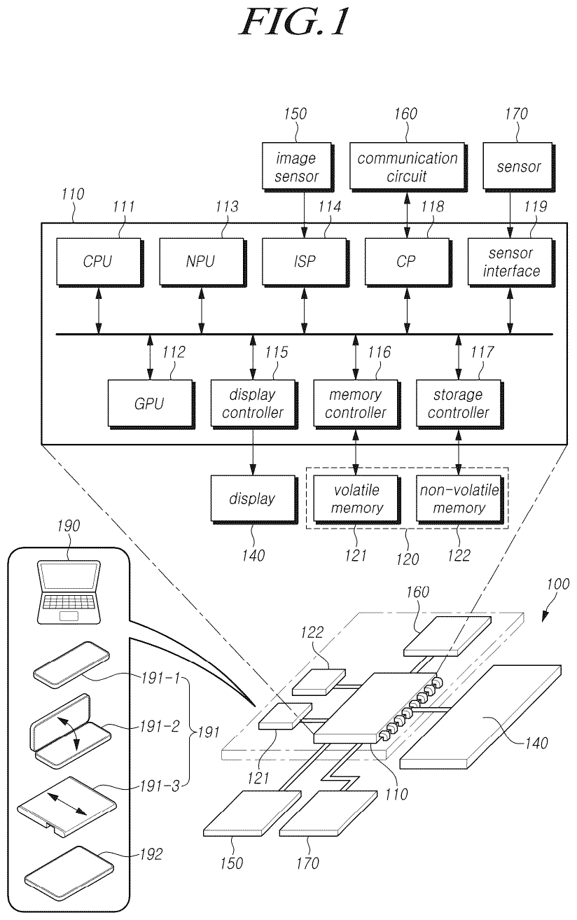

FIG. 1 is a block diagram illustrating an example configuration of electronic device 100 capable of performing the operations described herein according to one or more embodiment(s).

Referring to FIG. 1, the electronic device 100 may be one of various types of electronic devices, such as a notebook computer 190, smartphones 191 having various form factors (e.g., a bar-type smartphone 191-1, a foldable smartphone 191-2, or a slidable (or rollable) smartphone 191-3), a tablet PC 192, a cellular telephone (not shown), and any other similar computing devices (not shown). The components illustrated in FIG. 1, the relationships thereof, and the functions thereof are merely for illustration, and are not intended to limit the implementations described or claimed in the disclosure thereto. The electronic device 100 may be referred to as a mobile device, a user equipment, a multifunctional device, a portable device, or a server.

The electronic device 100 may comprise various components including at least one processor (e.g., including processing circuitry) 110 (hereinafter, the processor 110), at least one memory 120 (hereinafter, the memory 120), at least one display 140 (hereinafter, the display 140), at least one image sensor 150 (hereinafter, the image sensor 150), at least one communication circuit (e.g., including communication circuitry) 160 (hereinafter, the communication circuitry 160), and/or at least one sensor 170 (hereinafter, the sensor 170). The aforementioned components are merely of an example. For example, the electronic device 100 may comprise other components (e.g., a power management integrated circuitry (PMIC), an audio processing circuitry, an antenna, a rechargeable battery, or an input/output interface). For example, some components may be omitted from the electronic device (100). For example, some components may be integrated into one component.

The processor 110 may be implemented as one or more integrated circuit (or circuitry) (IC) chips and may perform various data processing. The processor 110 may include at least one electrical circuitry and may process instructions (or program, data, and so on) stored in the memory 120 individually or collectively in a distributed manner. The processor 110 may include a processor assembly that includes one or more processing circuitries. The processor may include any processing circuitry that may be operative for controlling operations and performance of one or more components (e.g., the memory 120, a display 140, the image sensor 150, the communication circuitry 160, and/or the sensor 170) of the electronic device. For example, the processor 110 (e.g., an application processor (AP)) may be implemented as a system on chip (SoC) (e.g., one chip or chipset). For example, the processor 110 may be implemented as a plurality of cores (or at least one core circuitry), a plurality of chips, or a plurality of chipsets. For example, the processor 110 may comprise one or more processing circuitry. For example, the processor 110 may comprise one or more processing circuitry which are individually and/or collectively configured to perform various functions of the disclosure. As a non-limiting example, at least a portion of the processor 110 may be included in a first chip of the electronic device 100 and at least another portion of the processor 110 may be included in a second chip of the electronic device 100 different from the first chip of the electronic device 100.

For example, the processor 110 may comprise a central processing unit (CPU) 111, a graphics processing unit (GPU) 112, a neural processing unit (NPU) 113, an image signal processor (ISP) 114, a display controller 115, a memory controller 116, a storage controller 117, a communication processor (CP) 118, and/or a sensor interface 119. These components of the processor 110 are merely of an example. Each of the CPU 111, GPU 112, NPU 113, ISP 114 and CP 118 may include various processing circuitry (see description of the processor 110 above). For example, the processor 110 may further comprise other components. For example, some components of the processor 110 may be omitted from the processor 110. For example, some components of the processor 110 may be included as separate components of the electronic device 100 outside the processor 110. For example, some components of the processor 110 (e.g., the memory controller 116) may be included in other components of the electronic device 100 (e.g., at least a portion of the memory 120, an interface (e.g., usable for connecting to at least one component of the electronic device 100), the display 140, and/or the image sensor 150).

The processor 110 may cause other components of the electronic device 100 to perform various operations by executing instructions stored in the memory 120. The CPU 111 (or a central processing circuitry) may be configured to control the components of the processor 110 based on execution of instructions stored in the memory 120 (e.g., the volatile memory 121 and/or the non-volatile memory 122). The GPU 112 (or a graphic processing circuitry) may be configured to execute parallel computations (e.g., rendering). The NPU 113 (or a neural processing circuitry, or an AI chip) may be configured to execute operations (e.g., convolution computations) for an AI model. The ISP 114 (or an image signal processing circuitry) may be configured to process a raw image obtained from the image sensor 150 in a format suitable for a component in the electronic device 100 or a component of the processor 110. The display controller 115 (or a display control circuitry, or a display processing unit (DPU)) may be configured to process an image obtained from the CPU 111, the GPU 112, the ISP 114, or the memory 120 (e.g., the volatile memory 121) in a format suitable for the display 140. The memory controller 116 (or a memory control circuitry) may be configured to control reading data from the volatile memory 121 and writing data to the volatile memory 121. The storage controller 117 (or a storage control circuitry) may be configured to control reading data from the non-volatile memory 122 and writing data to the non-volatile memory 122. The CP 118 (or a communication processing circuitry) may be configured to process data obtained from a component of the processor 110 in a format suitable for transmission to another electronic device via the communication circuitry 160, or to process data obtained from another electronic device via the communication circuitry 160 in a format suitable for processing of the component of the processor 110. For example, the communication circuitry 160 may comprise one or more communication circuitry. The sensor interface 119 (or a sensing data processing circuitry, a sensor hub) may be configured to process data on a state of the electronic device 100 and/or a state around the electronic device 100, obtained through the sensor 170, in a format suitable for a component of the processor 110.

The memory 120 may comprise one or more storage mediums (or one or more storage devices). For example, the memory 120 may include a memory assembly that includes one or more storage mediums. For example, the one or more storage mediums may comprise a permanent memory (e.g., the non-volatile memory 122) such as a hard drive, a flash memory, a read-only memory (ROM), a semi-permanent memory (e.g., the volatile memory 121) such as a random access memory (RAM), a storage (or a storage assembly) of any other suitable type, or any combination thereof. The memory 120 may comprise a cache memory which is a memory of one or more different types used to store data for performing a function or feature of the electronic device 100 at least temporarily. As a non-limiting example, the cache memory may be included in the processor 110. The memory 120 may be fixedly embedded within the electronic device 100, or may be incorporated onto one or more suitable types of components that may be repeatedly inserted into the electronic device 100, and removed from the electronic device 100 (e.g., a subscriber identity module (SIM) card, and/or a secure digital (SD) card).

For example, the memory 120 may store one or more software applications such as an operating system (or a system) software application, a firmware software application, a driver software application, a plug-in (e.g., add-in, add-on, and/or applet) software application, and/or any other suitable software application. For example, the one or more software applications may include instructions executable by the processor 110. For example, the memory 120 may store instructions callable by an application programming interface (API). For example, the memory 120 may store instructions in a library.

According to an example, the electronic device 100 may execute an instance of at least one AI model. The instance may be, e.g., an object corresponding to a program (or application) such as an AI model. The instance may be referred to as a replica, a pod, a container, or a virtual machine, and its name is not limited. The number of instances may correspond to the size of a resource (e.g., GPU 112 or NPU 113), and accordingly, the number of instances may be used interchangeably with the size of the resource, or the instance may be used interchangeably with the resource. The AI model may include various processing circuitry and/or processors. For example, each “processor” or “model” herein may include various processing circuitry, and/or may include multiple processors. For example, as used herein, including the claims, the term “processor” or “model” may include various processing circuitry, including at least one processor, wherein one or more of at least one processor, individually and/or collectively in a distributed manner, may be configured to perform various functions described herein. As used herein, when “a processor,” “at least one processor,” “a model,” “at least one model,” and “one or more processors” are described as being configured to perform numerous functions, these terms cover situations, for example and without limitation, in which one processor and/or model performs some of recited functions and another processor(s) and/or model(s) performs other of recited functions, and also situations in which a single processor and/or model may perform all recited functions. Additionally, the at least one processor may include a combination of processors performing various of the recited/disclosed functions, e.g., in a distributed manner. At least one processor may execute program instructions to achieve or perform various functions. Likewise, the at least one model may include a combination of circuitry and/or processors performing various of the recited/disclosed functions, e.g., in a distributed manner. At least one processor and/or model may execute program instructions to achieve or perform various functions.

As an example, a plurality of user requests may be input to the electronic device 100. The user requests may be associated with a service. The user request may be processed by a first instance of the first AI model, and a first processing result may be provided from the first instance of the first AI model. The first processing result may be processed by the first instance of the second AI model, and accordingly, a second processing result may be provided by the first instance of the second AI model. By the sequential processing of the processing results, the first instance of the Mth AI model may receive and process an N−1th processing result. The first instance of the Mth AI model may provide the Nth processing result as a response. Accordingly, a response corresponding to the user request may be provided.

Based on the above-described process, responses respectively corresponding to a plurality of user requests may be provided. On the other hand, since processing should be performed by an instance, it may take a relatively long time (hereinafter referred to as a “response time”) to provide responses respectively corresponding to the plurality of user requests. The response time may affect latency in the corresponding instance. In order to reduce the response time, the electronic device 100 may increase the number of instances of at least one AI model, which may be referred to as scaling out. However, there may be limitations in increasing the number of instances due to hardware and/or software constraints of the electronic device 100 and/or parameters of the AI model (e.g., LLM).

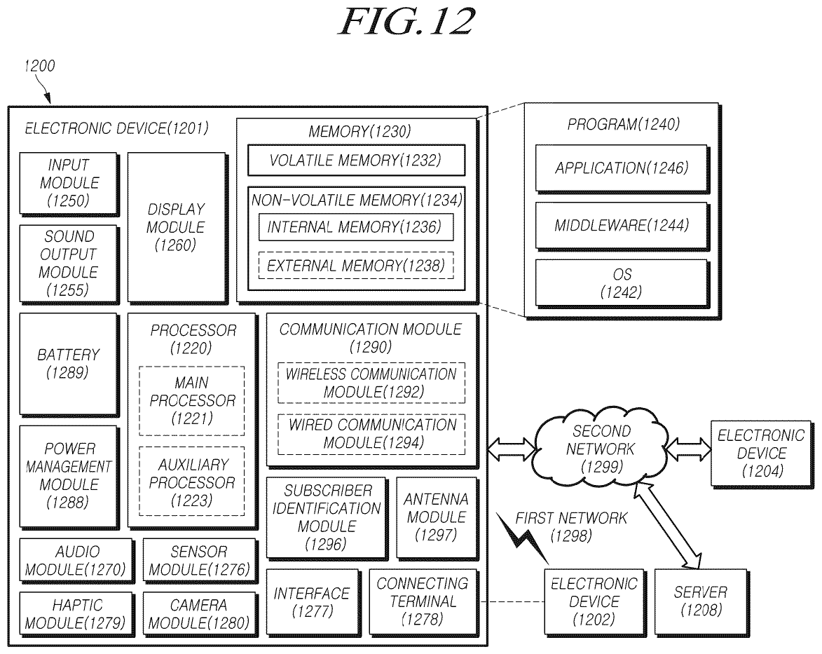

In an example, the AI model may be generated through machine learning. The machine learning may be performed by, e.g., the electronic device 100 itself capable of operating an on-device AI. The machine learning may be performed, e.g., through a separate external server (e.g., the server 1208 of FIG. 12) based on a network environment (e.g., the network environment 1200 of FIG. 12). In this case, the learning algorithm may include, e.g., supervised learning, unsupervised learning, semi-supervised learning, or reinforcement learning, but is not limited to the above-described examples.

According to an example, the AI model may be an artificial neural network model created in a designated language and including a plurality of layers and/or operations (or computations). For example, the AI model may include a feedforward neural network (FNN), a deep neural network (DNN), a convolutional neural network (CNN), a region with convolution neural network (R-CNN), a region proposal network (RPN), a recurrent neural network (RNN), a stacking-based deep neural network (S-DNN), a state-space dynamic neural network (S-SDNN), a deconvolution network, a restricted Boltzmann machine (RBM), a deep belief network (DBN), a bidirectional recurrent deep neural network (BRDNN), deep Q-networks, a fully convolutional network, a long short-term memory (LSTM) network, a classification network, or a combination of two or more thereof, but is not limited thereto. According to an example, the AI model may be trained with designated data, obtain input data, and perform an operation based on the input data to generate output data. In addition to the hardware structure, the AI model may additionally or alternatively include a software structure.

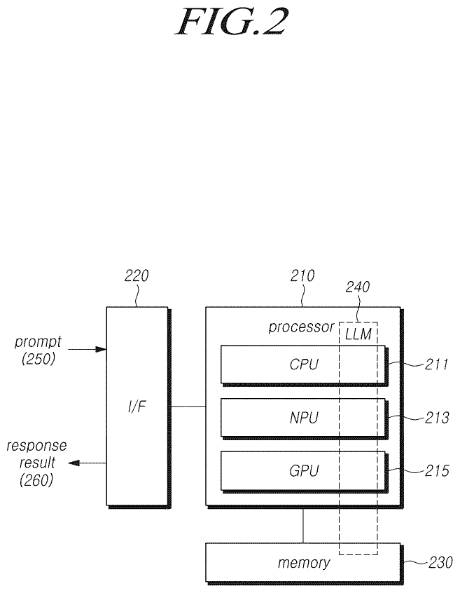

The electronic device 100 may adopt speculative decoding as a method for reducing response time and/or enhancing operation speed in the AI model. For example, the speculative decoding is used to operate an AI model, such as LLM, in an environment where constraints to the amount of computation or memory size exist. For example, the speculative decoding may obtain tokens corresponding to the prompt by a small model (e.g., a draft model) corresponding to a first model and a large model (e.g., a target model) corresponding to a second model paired with each other. In the disclosure, the first model, small model or draft model may be used with the same technical meaning, and the second model, large model or target model may be used with the same technical meaning. The prompt (e.g., the prompt 250 of FIG. 2) may be, e.g., a command or query that the user transmits to the AI model for a conversation with the AI model. For example, the prompt may serve as a communication window between the user and the generative AI model. The AI model should be able to accurately analyze or understand the prompt in order to provide accurate information desired by the user. The large model may have high accuracy due to the large amount of computation and/or number of parameters that may be processed but may have a slow processing speed. The small model may have a high processing speed due to a small amount of computation and/or number of parameters that may be processed, but may have a low accuracy. Taking advantage of these characteristics, the speculative decoding allows tokens quickly generated by the small model to be verified in the large model. For example, the electronic device 100 may perform a speculative decoding operation in which the small model consecutively generates output tokens, and the large model identifies the accuracy of each output token using a predetermined unit (e.g., a specific number N) of output tokens generated by the small model as an input.

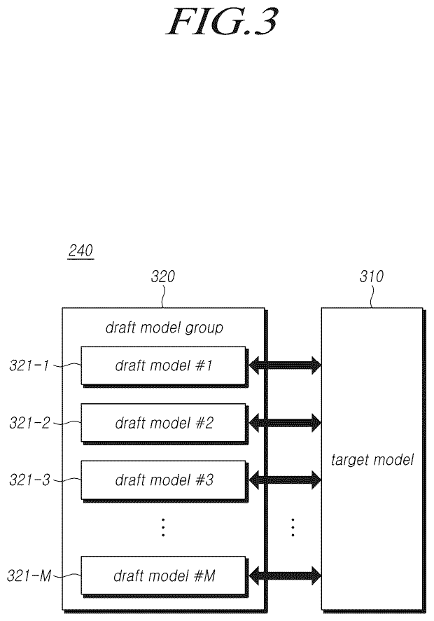

The speculative decoding may be optimized by the size of the small model and/or the size of the large model. The size of the small model and/or the size of the large model may correspond to the number of parameters. The size of the small model and/or the size of the large model may be determined, e.g., by the number of parameters connecting the nodes in a neural network to which nodes included in the corresponding model are connected. For example, an AI model may have hundreds of millions, tens of billions, or trillions of parameters or more. The size of the small model and/or the size of the large model may be expressed as ‘large/same/small’ or ‘many/same/small’. For example, in the following description, the small model (e.g., the draft model 321-1, 321-2, 321-3, . . . , 321-M of FIG. 3) is expressed as ‘small in size’ relative to the large model (e.g., the target model 310 of FIG. 3). For example, in the following description, when the large model (e.g., the target model 310 of FIG. 3) has the same size as the small model (e.g., the draft models 321-1, 321-2, 321-3, . . . , 321-M of FIG. 3), they are expressed as ‘same size’. For example, in the following description, the large model (e.g., the target model 310 of FIG. 3) is expressed as ‘having a large size relative to the small model (e.g., the draft models 321-1, 321-2, 321-3, . . . , 321-M of FIG. 3).

According to an example, if the size of the large model is fixed, the optimization (e.g., the accuracy and/or satisfaction) of the speculative decoding may be determined by the size of the small model. For example, the small model and/or the large model may be distributed, optimized for the operation environment by pre-securing sets of various input data and answer data of users as learning data and through training with the pre-secured learning data. In the optimization, the size of the small model and/or the large model may be one of the main requirements. This is because the accuracy of the results in the AI model is proportional to the size of the small model and/or large model, but the speed of operation to obtain the results is inversely proportional to the size of the small model and/or large model. In other words, as the size of the small model and/or the large model increases, the accuracy may increase, but the operation speed may be slowed. Further, the accuracy of the results in the AI model is largely proportional to the number of parameters in the model, but the operation speed to obtain the results is inversely proportional to the number of parameters in the model. In other words, when the number of parameters in the model increases, the accuracy may increase, but the operation speed may decrease.

Given the foregoing, an average of accuracy met by various users may be specified, and the size of a small model and/or large model converging into the average may be determined, which may, however, fail to provide sufficient satisfaction to the user due to various prompts. For example, satisfactory results may be provided in terms of accuracy for relatively simple tasks, but unsatisfactory results may be provided in terms of accuracy for relatively complex tasks. Therefore, there may be a need for a model selection method that may selectively adopt the size of a small model (e.g., a draft model) and/or a large model (e.g., a target model) considering accuracy and/or output satisfaction for the input during speculative decoding.

According to an example, in the electronic device 100, a plurality of draft models may generate a specific number (N) of initial tokens corresponding to the prompt, the target model may verify initial tokens for each draft model, and one draft model determined among the plurality of draft models may be applied for speculative decoding based on the verification result. The draft model to be applied for the speculative decoding may be determined based on, e.g., a probability distribution based on a probability value of tokens generated from the plurality of draft models and a probability value of tokens generated from the target model using tokens generated from the plurality of draft models as an input. The draft model to be applied for the speculative decoding may be determined considering, e.g., the size of the draft model. For example, when there are the plurality of draft models determined based on the probability distribution, among the plurality of draft models determined based on the probability distribution of output tokens, if the probability distribution is closest or within a specific error range, the draft model having the smallest size may be finally determined to increase the operation speed. For example, among draft models having the same size, a draft model in which the probability distribution is most similar to the probability distribution of the target model, or the probability distribution is within a specific error range with respect to the probability distribution of the target model may be selected for speculative decoding. As an example, among the draft models having the same size, a draft model having a relatively high probability distribution may be selected for speculative decoding. As an example, among the draft models having the same size, a draft model suitable for each theme may be selected for speculative decoding. In this case, the electronic device 100 may optimize the ability and/or latency of processing natural language.

FIG. 2 is a block diagram illustrating an example configuration for allowing an AI model to operate in an electronic device (e.g., the electronic device 100 of FIG. 1) according to one or more embodiment(s).

Referring to FIG. 2, an electronic device 100 may include a processor (e.g., including processing circuitry) 210 (e.g., the processor 110 of FIG. 1), a memory 230 (e.g., the memory 120 of FIG. 1), and/or an interface (IF) (e.g., including interface circuitry) 220 (e.g., the display 140 of FIG. 1). The electronic device 100 may be a device for providing a service associated with at least one AI model.

The at least one AI model may be based on a natural language processing (NLP) technology. For example, the NLP technology may refer, for example, to a technology in which the electronic device 100 understands or processes natural language (hereinafter referred to as a “prompt 250”) that may be expressed as the user's input, e.g., a voice and/or text. The electronic device 100 may understand natural language through NLP, determine human intentions based on the understood natural language, and/or transmit information in a language that may be understood by humans. For example, the AI model may process the user input entered to the prompt 250 right away. The AI model may iterate inference to generate a token at each iteration time. In order to understand human language, the NLP may predict the probability of the next word or token of a given text by learning the order of words or tokens. The token is a basic unit for processing or understanding the prompt in the AI model. The main techniques of the NLP include tokenization, part-of-speech tagging, syntax analysis, entity name recognition, or emotional analysis of the prompt corresponding to the user's input.

The at least one AI model may be based on a language model (LM) technology. The LM technology may predict the probability of each word or token (hereinafter collectively referred to as a ‘token’) based on the sequence of words or tokens. For example, the LM technology may play a role to predict a token that may come next consecutively from a preceding token. In other words, the LM may be an AI model trained to output the most statistically appropriate token based on the prompt. For example, the electronic device 100 may include an LLM 240. The LLM 240 included in the electronic device 100 may be a single generative LLM. The LLM 240 may be an ultra-large deep learning model pre-trained based on a vast amount of data. The LLM 240 may provide the ability to predict the user's intention based on a relatively small number of prompts. The LLM may be used for generative AI that generates content based on the prompt input in human language or text form, for example.

In an embodiment, LLM may be referred to as a LM comprising artificial neural networks, pre-trained with vast amounts of data (e.g., text data). The LLM may include about 10 times more parameters (e.g., about 100 billion or more parameters) than a general language model. The LLM may use a transformer artificial neural network structure based on an attention mechanism. The attention mechanism allows the AI model to focus on an important part within the input data. The attention mechanism may be used for output data prediction by predicting the degree to which at least a part of the time series input data (e.g., the input data such as voice and video or input data of some layers of the neural network) contributes to the intermediate or final output of the neural network. As an example, the RNN structure may sequentially process each element of the sequence. In the RNN structure, prediction performance for a case in which there is information dependence between long time series distances may be deteriorated. However, by controlling the degree of attention within the overall (or partial) context of the input data, the attention mechanism may take into account the dependence on information between long time series distances.

For example, the transformer may include an encoder-decoder structure. The encoder may process input data and output compression information (e.g., an attention mechanism). The decoder may process the compression information and output the output data in token units. The encoder and/or decoder may include an independent attention network. The transformer may include a cross-attention network connecting the encoder and the decoder.

For example, LLM may be trained by two operations: pre-training and fine-tuning. The pre-training may include a process of allowing the LLM to process a vast amount of text data and learn general language knowledge. The pre-training may include, e.g., self-supervised learning to predict the next word using the previous word sequence of the text sequence. The fine tuning may include a process of training a large-scale language model to be suitable for a specific domain (e.g., chatbot, translation, summary, Q&A) or task. The fine tuning may be additionally supervised-trained (or adaptive trained) using, e.g., a dataset suitable for domain purposes based on a pre-trained model.

According to an example, the LLM may perform a task with a text input including a natural language called the prompt 310. For example, the LLM may include BERT (bidirectional encoder representations from transformer) and GPT (generative pre-trained transformer). The expression ‘LLM’ may refer to the neural network model itself but may also refer to a model of an LLM-based application (e.g., chatbot, translation, summary, text classification, sentence generation). For example, a chatbot such as ChatGPT may be referred to as an LLM. The ‘LLM’ may also include an inference engine comprising various circuitry and/or executable program instructions using an LLM neural network model. For example, “inputting an input prompt into LLM” may be referred to as “inputting the input prompt to an LLM-based inference engine”.

The NLP described above may refer to an AI model for the electronic device 100 to understand or analyze human language, whereas the LLM may be an AI model for predicting the next word or sentence (e.g., subsequent token) based on given data (e.g., the preceding token). The NLP is used for search engine, machine translation, or emotional analysis. The LLM is used for sentence generation, automatic completion, or speech recognition. The electronic device 100 may provide, e.g., a generative AI service using NLP to understand the user's query and LLM to generate an appropriate answer thereto.

The processor 210 may execute software (e.g., a program) to control at least one other component (e.g., a hardware or software component) of the electronic device 100 electrically connected thereto. The processor 210 may perform various data processing or computations. As at least a part of the data processing or operation, the processor 210 may store a command or data received from another component (e.g., the I/F 220) in the memory 230 (which may be, e.g., a volatile memory, but is not limited). As at least a part of the data processing or operation, the processor 210 may process commands or data stored in the memory 230 (which may be, e.g., a volatile memory, but is not limited thereto). As at least a part of the data processing or operation, the processor 210 may store data of the result of processing the commands or data in the memory 230 (which may be, e.g., a non-volatile memory, but is not limited thereto). The processor 210 may include a CPU (e.g., including processing circuitry) 211 (e.g., the CPU 111 of FIG. 1), an NPU (e.g., including processing circuitry) 213 (e.g., the NPU 113 of FIG. 1), and/or a GPU (e.g., including processing circuitry) 215 (e.g., the GPU 112 of FIG. 1), each of which include a processing circuit, but is not limited thereto. Each “processor”, “processing unit” (PU) or “model” herein includes processing circuitry, and/or may include multiple processors. For example, as used herein, including the claims, the term “processor” or “model” may include various processing circuitry, including at least one processor, wherein one or more of at least one processor, individually and/or collectively in a distributed manner, may be configured to perform various functions described herein. As used herein, when “a processor,” “at least one processor,” “a model,” “at least one model,” and “one or more processors” are described as being configured to perform numerous functions, these terms cover situations, for example and without limitation, in which one processor and/or model performs some of recited functions and another processor(s) and/or model(s) performs other of recited functions, and also situations in which a single processor and/or model may perform all recited functions. Additionally, the at least one processor may include a combination of processors performing various of the recited/disclosed functions, e.g., in a distributed manner. At least one processor may execute program instructions to achieve or perform various functions. Likewise, the at least one model may include a combination of circuitry and/or processors performing various of the recited/disclosed functions, e.g., in a distributed manner. At least one processor and/or model may execute program instructions to achieve or perform various functions.

The memory 230 may store various data used by at least one component (e.g., the processor 210 and/or the I/F 220) of the electronic device 100. The various data may include, for example, software (e.g., the program) and input data or output data for a command related thereto. The memory 230 may include a volatile memory and/or a non-volatile memory. The memory 230 may include a hard disk, a ROM, a RAM (e.g., SRAM, PSRAM, or DRAM), a cache memory, and/or a register, but its implementation is not limited. Some of the above-described entities (which may be, e.g., a register, but is not limited thereto) may be implemented as part of the processor 210, and the implementation form is not limited. At least one AI model (e.g., the LLM 240) for instance execution may be stored in the memory 230.

The memory 230 may store at least one instruction. The processor 210 may execute at least one instruction stored in the memory 230. The at least one instruction may, when executed by the processor 210, enable the electronic device 100 to perform at least one operation. For example, as at least one instruction is executed by the processor 210, at least one other component may be controlled, and/or various data processing or operations may be performed. That one operation performed by the processor 210 may refer, for example, to the corresponding operation being performed, e.g., by one entity (which may be, e.g., a main processor, but is not limited thereto) included in the processor 210. That one operation is performed may refer to, e.g., a specific operation being performed by a plurality of entities (e.g., a plurality of processors) (or by control). That a plurality of operations are performed may refer to, e.g., all of the plurality of operations being performed by one entity (which may be, e.g., a main processor, but is not limited thereto). That a plurality of operations are performed may refer to, e.g., some of the plurality of operations being performed by at least one entity, and some remaining operations are performed by at least one other entity. At least one instruction enabling the execution of one or more operations may be stored in one memory, e.g., or may be distributed and stored in each of a plurality of memories.

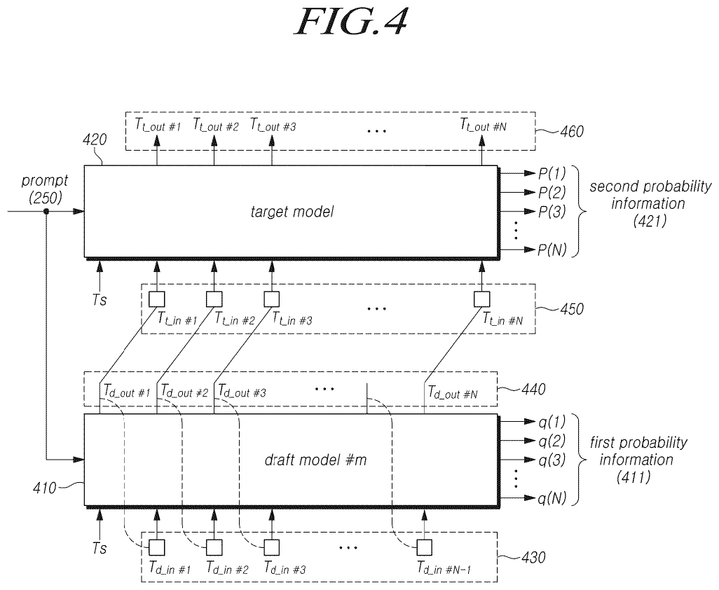

In the electronic device 100, the LLM 240 may share resources (e.g., the data processing or computing capabilities) corresponding to some or all of at least one processor included in the processor 210 and/or resources (e.g., the data recording areas) corresponding to some or all of the memories 230. For example, the LLM 240 may be operated by at least one of the CPU 211, the NPU 213, and the GPU 215. The LLM 240 may be allocated at least a partial area of the memory 230 and performed by the CPU 211 alone. The LLM 240 may be allocated at least a partial area of the memory 230 and performed by the NPU 213 alone. The LLM 240 may be allocated at least a partial area of the memory 230 and performed by the GPU 215 alone. The LLM 240 may be allocated at least a projection area of the memory 230 and performed in cooperation between the CPU 211 and the NPU 213. For example, the LLM 240 may be allocated at least a partial area of the memory 230 and performed in cooperation between the CPU 211 and the GPU 215. The LLM 240 may be allocated at least a partial area of the memory 230 and performed in cooperation between the NPU 213 and the GPU 215. For example, the LLM 240 may be allocated at least a partial area of the memory 230 and performed in cooperation between the CPU 211, the NPU 213, and the GPU 215. Various embodiments to be described below in the disclosure are not limited to a combination of components for performing the LLM 240, but may be implemented and/or applied based on any combination thereof. The LLM 240 is described in greater detail below with reference to the remaining drawings including FIGS. 3 and 4.

According to an example, the LLM 240 may include a target model (e.g., the target model 310 of FIG. 3) and a plurality of draft models (e.g., the draft model #1 321-1, the draft model #2 321-2, the draft model #3 321-3, . . . , the draft model #N 321-M of FIG. 3). The target model 310 may have a large size relative to the plurality of draft models 321-1, 321-2, 321-3, . . . , 321-M. Here, M may be a positive integer. The plurality of draft models 321-1, 321-2, 321-3, . . . , 321-M may have different sizes. The size of the draft models 321-1, 321-2, 321-3, . . . , 321-M may determine processing capabilities and/or latency. For example, a draft model having a large size may generate tokens having a higher possibility (e.g., accuracy) to match the information included in the prompt 250 relatively as compared with a draft model having a small size. However, a draft model having a large size may have a relatively large latency compared to a draft model having a small size. For example, the target model 310 may have higher accuracy due to more processable computation amount and/or parameters but have low processing rate, and the plurality of draft models 321-1, 321-2, 321-3, . . . , 321-M may have a high processing rate due to smaller processable computation amount and/or fewer parameters but have low accuracy which needs to be compensated for. For this reason, the electronic device 100 adopts an AI model based on speculative decoding in which the target model 310 and the draft model operate in pairs. According to an example, the LLM 240 including at least one target model 310 and a plurality of draft models 321-1, 321-2, 321-3, . . . , 321-M need adaptively select a preferred draft model among the plurality of draft models 321-1, 321-2, 321-3, . . . , 321-M to provide speculative decoding for the optimal processing capability and/or latency. The preferred draft model may configure a pair with the target model for speculative decoding. The LLM 240 may determine the preferred draft model considering a probability distribution of a specific number of output tokens respectively generated by the plurality of draft models 321-1, 321-2, 321-3, . . . , 321-M when performing speculative decoding to obtain an initial specific number (e.g., N) of tokens corresponding to the prompt input by the user.

According to an example, the LLM 240 may provide the prompt 250 corresponding to the user's input to the target model 310 and the plurality of draft models 321-1, 321-2, 321-3, . . . , 321-M. The LLM 240 may allow a start token (or initial token) Ts to be generated by the target model 310 in response to an input of the prompt 250. The LLM 240 may generate a specific number (e.g., four) of sequential output tokens based on the prompt 250 from the plurality of draft models 321-1, 321-2, 321-3, . . . , 321-M, respectively, in response to the input of the start token.

According to an example, the LLM 240 may generate tokens respectively corresponding to the plurality of draft models 321-1, 321-2, 321-3, . . . , 321-M and obtain probability values (e.g., primary probability values q(1), q(2), q(3), . . . , q(N)) which are the probability information (e.g., the probability information 411 of FIG. 4) about the generated tokens. The LLM 240 may obtain the probability values (e.g., q(1-1), q(2-1), q(3-1), . . . , q(N-1)) of the tokens generated corresponding to, e.g., the first draft model 321-1. The LLM 240 may obtain the probability values (e.g., q(1-2), q(2-2), q(3-2), . . . , q(N-2)) corresponding to, e.g., the second draft model 321-2. The LLM 240 may obtain the probability values (e.g., q(1-3), q(2-3), q(3-3), . . . , q(N-3)) corresponding to, e.g., the third draft model 321-3. The LLM 240 may obtain the probability values (e.g., q(1-M), q(2-M), q(3-M), . . . , q(N-M)) corresponding to, e.g., the Mth draft model 321-M.

The LLM may use the output tokens respectively generated by the plurality of draft models 321-1, 321-2, 321-3, . . . , 321-M in the target model in response to the input of the start token Ts and verify the plurality of draft models 321-1, 321-2, 321-3, . . . , 321-M based on the input tokens (e.g., the output tokens generated by the draft model).

According to an example, the LLM 240 may obtain the probability values (e.g., the secondary probability values p(1), p(2), p(3), , p(N)) of the probability information (e.g., the second probability information 421 of FIG. 4) corresponding to the tokens respectively generated by the plurality of draft models 321-1, 321-2, 321-3, . . . , 321-M by the target model 310. The LLM 240 may operate to obtain the probability values (e.g., p(1-1), p(2-1), p(3-1), . . . , p(N-1)) corresponding to the first draft model 321-1 by the target model 310. The LLM 240 may operate to obtain the probability values (e.g., p(1-2), p(2-2), p(3-2), . . . , p(N-2)) corresponding to the second draft model 321-2 by the target model 310. The LLM 240 may operate to obtain the probability values (e.g., p(1-3), p(2-3), p(3-3), . . . , p(N-3)) corresponding to the third draft model 321-3 by the target model 310. The LLM 240 may operate to obtain the probability values (e.g., p(1-M), p(2-M), p(3-M), . . . , p(N-M)) corresponding to the Mth draft model 321-M by the target model 310.

According to an example, the LLM 240 may determine the probability distribution for each draft model based on the probability values (e.g., the primary probability values q(1), q2), q(3), . . . , q(N) of FIG. 4) of the probability information (e.g., the first probability information 411 of FIG. 4) determined for each of the plurality of draft models 321-1, 321-2, 321-3, . . . , 321-M and the probability values (e.g., the secondary probability values (p(1), p(2), p(3), . . . , p(N) of FIG. 4) of the probability information (e.g., the second probability information 421 of FIG. 4) determined for the target model 310. The above probability distribution is, e.g., the primary probability values (q(1) and q2), q(3), etc. determined by each draft model in response to the same output tokens. , The secondary probability values (p(1), p(2), p(3), etc.) determined by q(N) and the target model above (310). , It may be obtained by p(N). The same output token may be an output token matching the output tokens (e.g., the second output tokens (T_{t_out #1}, T_{t_out #2}, T_{t_out #3}, . . . , T_{t_out #N}) 460) of the target model 310 among the output tokens (e.g., the first output tokens (T_{d_out #1}, T_{d_out #2}, T_{d_out #3}, . . . , T_{d_out #N}) 440 or the second input tokens (T_{t_in #1}, T_{t_in #2}, T_{t_in #3}, . . . , T_{t_in #N}) 450) of each draft model. The LLM 240 may determine a draft model in which the probability distribution is relatively similar to the target model 310 among the plurality of draft models 321-1, 321-2, 321-3, . . . , 321-M as the preferred draft model.

According to an example, the LLM 240 may select one or more draft models in which the output tokens are identical to the output token generated by the target model 310 among the plurality of draft models 321-1, 321-2, 321-3, . . . , 321-M. The LLM 240 may determine a draft model in which the probability distribution is relatively similar to the target model among one or more selected draft models as the preferred draft model. The above probability distribution is, e.g., the primary probability values (q(1) and q2), q(3), etc. determined by each draft model in response to the same output tokens. , The secondary probability values (p(1), p(2), p(3), etc.) determined by q(N) and the target model above (310). , It may be obtained by p(N). The same output token may be an output token matching the output tokens (e.g., the second output tokens (T_{t_out #1}, T_{t_out #2}, T_{t_out #3}, . . . , T_{t_out #N}) 460) of the target model 310 among the output tokens (e.g., the first output tokens (T_{d_out #1}, T_{d_out #2}, T_{d_out #3}, . . . , T_{d_out #N}) 440 or the second input tokens (T_{t_in #1}, T_{t_in #2}, T_{t_in #3}, . . . , T_{t_in #N}) 450) of each draft model. The LLM 240 may determine a draft model in which the probability distribution is relatively similar to the target model 310 among the plurality of draft models 321-1, 321-2, 321-3, . . . , 321-M as the preferred draft model.

If determining the preferred draft model among the plurality of draft models 321-1, 321-2, 321-3, . . . , 321-M based on the initial specific number (e.g., N) of output tokens and the specific number of output tokens in response to the input of the prompt 250, the LLM 240 may generate the remaining tokens based on speculative decoding by taking a pair of the preferred draft model and the target model 310. If determining the preferred draft model corresponding to the prompt 250, the LLM 240 may maintain the existing model pair (e.g., the target model 310 and the preferred draft model) until all of the remaining tokens are generated.

The I/F 220 may receive a prompt 250 corresponding to an input from the user and transmit the received prompt 250 to the processor 210. The prompt 250 may be a medium that serves to guide an operation to be performed by the generative AI (e.g., the LLM 240) or a result to be generated in a desired direction. The prompt 250 may be the only window through which the user may communicate with the LLM 240. The prompt 250 needs to be clear and specific in order to obtain an answer close to the desired result from the LLM 240. The I/F 220 may receive the result processed by the LLM 240 from the processor 210 based on the prompt 250 and output a response result 260 of converting the result into natural language, which is a form (e.g., voice or text) that may be recognized by a human. The I/F 220 may receive or output a natural language in the form of, e.g., voice and/or text with at least one component such as a keyboard, touch panel, display, and/or speaker.

FIG. 3 is a block diagram illustrating an example configuration of an LLM (e.g., the LLM 240 of FIG. 2) equipped in an electronic device (e.g., the electronic device 100 of FIG. 1) according to one or more embodiment(s).

Referring to FIG. 3, an LLM 240 may include a target model 310 and a draft model group 320. The LLM 240 may be configured, e.g., in an on-device type, on the electronic device 100. In this case, the target model 310 and the draft model group 320 included in the LLM 240 may be included in the electronic device 100.

The draft model group 320 may include a plurality of draft models (e.g., the draft model #1 321-1, the draft model #2 321-2, the draft model #3 321-3, . . . , the draft model #N 321-M of FIG. 3). The target model 310 may have a large size relative to the plurality of draft models 321-1, 321-2, 321-3, . . . , 321-M. Some of the plurality of draft models 321-1, 321-2, 321-3, . . . , 321-M may have, e.g., the same size. The plurality of draft models 321-1, 321-2, 321-3, . . . , 321-M may have, e.g., different sizes. The draft model #1 321-1 may be relatively larger in size than, e.g., the draft model #2 321-2. The draft model #2 321-2 may be relatively larger in size than, e.g., the draft model #3 321-3. The size of the draft models 321-1, 321-2, 321-3, . . . , 321-M may determine processing capabilities and/or latency. For example, a draft model having a large size may generate tokens having a higher possibility (e.g., accuracy) to match the information included in the prompt (e.g., the prompt 250 of FIG. 2) relatively as compared with a draft model having a small size. However, a draft model having a large size may have a relatively large latency compared to a draft model having a small size.

According to an example, the plurality of draft models 321-1, 321-2, 321-3, . . . , 321-M may have the same or similar structures and/or complexities, but draft models trained to be specialized for different specific data sets may be used.

According to an example, as the plurality of draft models 321-1, 321-2, 321-3, . . . , 321-M, draft models which have the same structure, complexity, and/or number of NN parameters as the target model 310 or to which strong quantization has been applied (e.g., four-bit quantization) may be used.

The prompt 250 corresponding to the user's input may be provided to the target model 310 and the plurality of draft models 321-1, 321-2, 321-3, . . . , 321-M. The target model 310 may generate a start token (e.g., the start token Ts of FIG. 4) in response to the input of the prompt 250. The start token may instruct to initiate token generation and verification for analysis of the prompt 250 and/or understanding of natural language therethrough. The start token may be used as an initial input token of the target model 310 and the plurality of draft models 321-1, 321-2, 321-3, . . . , 321-M.

The plurality of draft models 321-1, 321-2, 321-3, . . . , 321-M may consecutively generate a specific number (N) (e.g., four) of output tokens based on the prompt 250 in response to the start token. Generation of the output tokens by the plurality of draft models 321-1, 321-2, 321-3, . . . , 321-M may be performed in the same time period. Generation of the output tokens by the plurality of draft models 321-1, 321-2, 321-3, . . . , 321-M may be performed in independent time periods. The independent time periods may be time periods that are completely separated without an overlapping time period. The independent time periods may be time periods that partially overlap but are not completely the same. N output tokens consecutively generated from some draft models among the plurality of draft models 321-1, 321-2, 321-3, . . . , 321-M may be the same. N output tokens consecutively generated from some draft models among the plurality of draft models 321-1, 321-2, 321-3, . . . , 321-M may be different. For example, the output tokens of at least two draft models differ from each other may refer, for example, to some output tokens among the output tokens respectively generated by the at least two draft models being the same. For example, the output tokens of at least two draft models differ from each other may refer, for example, to none of the output tokens respectively generated by the at least two draft models being identical.

The plurality of draft models 321-1, 321-2, 321-3, . . . , 321-M may predict one or more candidate tokens for the input token, determine probability information about each of the one or more candidate tokens, and output one candidate token as the output token considering the determined probability information for each candidate token. For example, the probability information may be determined by the probability value which is a numerical value of the possibility (e.g., accuracy) that the candidate token is to match the included in the prompt 250. The candidate tokens may have different pieces of probability information. Although the same candidate token is output from at least two draft models among the plurality of draft models 321-1, 321-2, 321-3, . . . , 321-M, the at least two draft models may differently predict the differences pieces of probability information for the corresponding candidate token. In this case, a relatively high probability value as generated by the corresponding draft model may indicate that the possibility that the corresponding candidate token is accurate is high, and a relatively low probability value as generated by the corresponding draft model may indicate that the possibility that the corresponding candidate token is accurate is low. The corresponding probability value may indicate the accuracy of the token generated by the trained draft model.

The reason why the output tokens are not identical, although the same prompt 250 is input to the plurality of draft models 321-1, 321-2, 321-3, . . . , 321-M, is that there is a difference in performance (accuracy or difference in size) between the plurality of draft models 321-1, 321-2, 321-3, . . . , 321-M. The reason why the same output token is generated, despite the difference in performance of the plurality of draft models 321-1, 321-2, 321-3, . . . , 321-M, is that the performance difference may not be enough to affect the prediction of the next output token by a specific input token.

The plurality of draft models 321-1, 321-2, 321-3, . . . , 321-M may use the output token as an input to the next step. Accordingly, the plurality of draft models 321-1, 321-2, 321-3, . . . , 321-M may sequentially perform the operation of obtaining the next output token using the preceding output token as an input token until N output tokens are obtained after starting the operation in response to the start token.

The target model 310 may receive N output tokens respectively output from the plurality of draft models 321-1, 321-2, 321-3, . . . , 321-M as inputs. The target model 310 may generate N output tokens using the N output tokens respectively received from the plurality of draft models 321-1, 321-2, 321-3, . . . , 321-M, as inputs. The N output tokens may be generated for each draft model. For example, the target model 310 may perform the operation of generating N output tokens using the N output tokens output for each of the plurality of draft models 321-1, 321-2, 321-3, . . . , 321-M as inputs in the same time period. The same time period may refer, e.g., to the time periods completely overlapping each other. For example, the target model 310 may perform the operation of generating N output tokens using the N output tokens output for each of the plurality of draft models 321-1, 321-2, 321-3, . . . , 321-M as inputs in independent time periods. The independent time periods may be time periods that are completely separated without an overlapping time period. The independent time periods may be time periods that partially overlap but are not completely the same. The target model 310 may sequentially generate N output tokens respectively corresponding to the plurality of draft models 321-1, 321-2, 321-3, . . . , 321-M in completely different time periods by sequentially inputting the N output tokens output for each of the plurality of draft models 321-1, 321-2, 321-3, . . . , 321-M. Such an operation may be implemented by a method in which the numbers of the output tokens output from the plurality of draft models 321-1, 321-2, 321-3, . . . , 321-M are the same, and key-value (Kv) cache data corresponding to each input is read from the memory (e.g., the memory 230 of FIG. 2) and managed for each draft model. For example, in generating a token, Kv cache data may refer, for example, to a cache system that stores intermediate results to relatively quickly perform a designated task. The target model 310 may quickly find the key value and the value in a manner of pre-storing the key values of the values of the tokens to be computed in the future in an attention structure in storing values corresponding to keys as data and operating the model.

N output tokens consecutively generated from some draft models among the plurality of draft models 321-1, 321-2, 321-3, . . . , 321-M may be the same. N output tokens consecutively generated from some draft models among the plurality of draft models 321-1, 321-2, 321-3, . . . , 321-M may be different. For example, the output tokens of at least two draft models differ from each other may refer, for example, to some output tokens among the output tokens respectively generated by the at least two draft models being the same. For example, the output tokens of at least two draft models differ from each other may refer, for example, to none of the output tokens respectively generated by the at least two draft models being identical.

The electronic device 100 may include predetermined components performing a function of determining a preferred draft model to be used for speculative decoding among the plurality of draft models 321-1, 321-2, 321-3, . . . , 321-M. The predetermined component may be, e.g., the LLM 240. The predetermined component may be, e.g., a specific function module included in the LLM 240. The predetermined component may be a specific function module by a combination of at least one or more of a CPU (e.g., the CPU 211 of FIG. 2), an NPU (e.g., the NPU 213 of FIG. 2), or a GPU (e.g., the GPU 215 of FIG. 2)) capable of processing other than the LLM 240 in the electronic device 100.

According to an example, the predetermined component may determine the probability distribution for each draft model based on the probability values (e.g., the primary probability values q(1), q2), q(3), . . . , q(N) of FIG. 4) of the probability information (e.g., the first probability information 411 of FIG. 4) determined for each of the plurality of draft models 321-1, 321-2, 321-3, . . . , 321-M and the probability values (e.g., the secondary probability values (p(1), p(2), p(3), . . . , p(N) of FIG. 4) of the probability information (e.g., the second probability information 421 of FIG. 4) determined for the target model 310. The above probability distribution may be obtained by, e.g., the primary probability values (q(1), (q2), q(3), , q(N)) determined by each draft model in response to the same output tokens, and the secondary probability values (p(1), p(2), p(3), . . . , p(N)) determined by q(N) and the target model above (310). The same output token may be an output token matching the output tokens (e.g., the second output tokens (T_{t_out #1}, T_{t_out #2}, T_{t_out #3}, . . . , T_{t_out #N}) 460) of the target model 310 among the output tokens (e.g., the first output tokens (T_{d_out #1}, T_{d_out #2}, T_{d_out #3}, . . . , T_{d_out #N}) 440 or the second input tokens (T_{t_in #1}, T_{t_in #2}, T_{t_in #3}, . . . , T_{t_in #N}) 450) of each draft model. The predetermined component may determine a draft model in which the probability distribution is relatively similar to the target model 310 among the plurality of draft models 321-1, 321-2, 321-3, . . . , 321-M as the preferred draft model.

For example, the LLM 240 may select one or more draft models in which the output tokens are identical to the output token generated by the target model 310 among the plurality of draft models 321-1, 321-2, 321-3, . . . , 321-M. The LLM 240 may determine a draft model in which the probability distribution is relatively similar to the target model among one or more selected draft models as the preferred draft model. The probability distribution may be obtained by the primary probability values q(1), q2), q(3), . . . , q(N) determined by each draft model and the secondary probability values (p(1), p(2), p(3), . . . , p(N) determined by the target model 310 corresponding to, e.g., the same output tokens. The same output token may be an output token matching the output tokens (e.g., the second output tokens (T_{t_out #1}, T_{t_out #2}, T_{t_out #3}, . . . , T_{t_out #N}) 460) of the target model 310 among the output tokens (e.g., the first output tokens (T_{d_out #1}, T_{d_out #2}, T_{d_out #3}, . . . , T_{d_out #N}) 440 or the second input tokens (T_{t_in #1}, T_{t_in #2}, T_{t_in #3}, . . . , T_{t_in #N}) 450) of each draft model. The predetermined component may determine a draft model in which the probability distribution is relatively similar to the target model 310 among the plurality of draft models 321-1, 321-2, 321-3, . . . , 321-M as the preferred draft model.

If determining the preferred draft model among the plurality of draft models 321-1, 321-2, 321-3, . . . , 321-M based on the initial specific number (e.g., N) of output tokens and the specific number of output tokens in response to the input of the prompt 250, the electronic device 100 may generate the remaining tokens based on speculative decoding by taking a pair of the preferred draft model and the target model 310. If determining the preferred draft model corresponding to the prompt 250, the electronic device 100 may maintain the existing model pair (e.g., the target model 310 and the preferred draft model) until all of the remaining tokens are generated.

In the above description, the target model 310 and the plurality of draft models 321-1, 321-2, 321-3, . . . , 321-M are configured, in an on-device type, on the electronic device 100, but the target model 310 may be operated by the server while the plurality of draft models 321-1, 321-2, 321-3, . . . , 321-M are operated by the electronic device 100.

According to an example, the electronic device 100 may consider operation states of the electronic device, such as the user, used solution, battery status, and/or heat generation situation, as criteria when selecting or determining a preferred draft model. The electronic device 100 may also apply criteria for selecting or determining the preferred draft model based on the AI model. In this case, the load for the AI model to select or determine the preferred draft model may be applied within a limit where it is not large enough to exceed a threshold level.

FIG. 4 is a diagram illustrating an example operation in which an electronic device (e.g., the electronic device 100 of FIG. 1) configures an LLM (e.g., the LLM 240 of FIG. 2) for speculative decoding according to one or more embodiment(s). In FIG. 4, a specific draft model is an mth draft model 410 (draft model #m) included in a plurality of draft models (e.g., the plurality of draft models 321-1, 321-2, 321-3, . . . , 321-M of FIG. 3). Here, m is an integer greater than or equal to 1 (one) and less than or equal to M, and M may be an integer larger than 1 (one). The configuration and/or operation described below may be equally applied to the remaining draft models except for the draft model #m 410 among the plurality of draft models 321-1, 321-2, 321-3, . . . , 321-M.

Referring to FIG. 4, an LLM based on speculative decoding (e.g., the LLM 240 of FIG. 2) may include a plurality of token flows. The plurality of token flows may include pairs of at least one target model 420 (e.g., the target model 310 of FIG. 3) and the plurality of draft models (e.g., the plurality of draft models 321-1, 321-2, 321-3, . . . , 321-M of FIG. 3). For convenience of description, the following description assumes one target model 420, but the configuration and/or operation described may be equally applied to a plurality of target models. The plurality of token flows may correspond to links where output tokens are transferred between the plurality of draft models 321-1, 321-2, 321-3, . . . , 321-M and the target model 420. For example, FIG. 4 illustrates a token flow in which N output tokens (T_{d_out #1}, T_{d_out #2}, T_{d_out #3}, . . . , T_{d_out #N}) 440 generated by the draft model #m 410 are transferred to N input tokens (T_{t_in #1}, T_{t_in #2}, T_{t_in #3}, . . . , T_{t_in #N}) 450 for the target model 420. Here, N may be a positive integer. The draft model #m 410 may be included in the plurality of draft models 321-1, 321-2, 321-3, . . . , 321-M. The token flow may include a plurality of paths for connecting N output ports included in the draft model #m 410 and N input ports included in the target model 420 in a one-to-one manner. The connections between the output ports of the draft model #m 410 and the input ports of the target model 420 may be identified by token identification index #x (where, 0<x≤N) of N output tokens (T_{d_out #1}, T_{d_out #2}, T_{d_out #3}, . . . , T_{d_out #N}) 440 (hereinafter, referred to as “primary output tokens”) and N input ports (T_{t_in #1}, T_{t_in #2}, T_{t_in #3}, . . . , T_{t_in #N}) 450 (hereinafter, referred to as “secondary input tokens”). For example, the token flow #m connecting the draft model #m 410 and the target model 420 may include a first path connecting the output port outputting the first output token T_{d_out #1} in the draft model #m 410 and the input port to which the first input token T_{t_in #1} is to be input from the target model 420. The first output token T_{d_out #1} may be one of the primary output tokens (T_{d_out #1}, T_{d_out #2}, T_{d_out #3}, . . . , T_{d_out #N}) 440. The first input token T_{t_in #1} may be one of the secondary input tokens (T_{t_in #1}, T_{t_in #2}, T_{t_in #3}, . . . , T_{t_in #N}) 450. The remaining paths included in the token flow #m may be defined based on the token identification index as described above.

The draft model #m 410 may use the prompt (e.g., the prompt 250 of FIG. 2) corresponding to the user input as an input. The target model 420 may use the prompt corresponding to the user input as an input. For example, the same prompt may be input to the draft model #m 410 and the target model 420. For example, the prompt input to the target model 420 may be processed or arbitrarily processed and input to the draft model #m 410. For example, the prompt input to the draft model #m 410 may be processed or arbitrarily processed and input to the target model 420.

A start token Ts may be input to a first input port among the plurality of input ports included in the draft model #m 410. The start token Ts may be input to the first input port among the plurality of input ports included in the target model 420. For example, the start token Ts may be a command or an identifier instructing to start token generation in response to the input of the prompt 250 by the user. The start token may be generated by, e.g., the target model 420 in response to the input of the prompt 250. The draft model #m 410 and/or the target model 420 may initiate token generation in response to the input of the start token Ts.

If the start token Ts is input, the draft model #m 410 may generate the primary output tokens (T_{d_out #1}, T_{d_out #2}, T_{d_out #3}, . . . , T_{d_out #N}) 440 corresponding to N input tokens (T_{d_in #1}, T_{d_in #2}, T_{d_in #3}, . . . , T_{d_in #N-1}) 430)(hereinafter referred to as “primary input tokens”) based on the prompt 250.

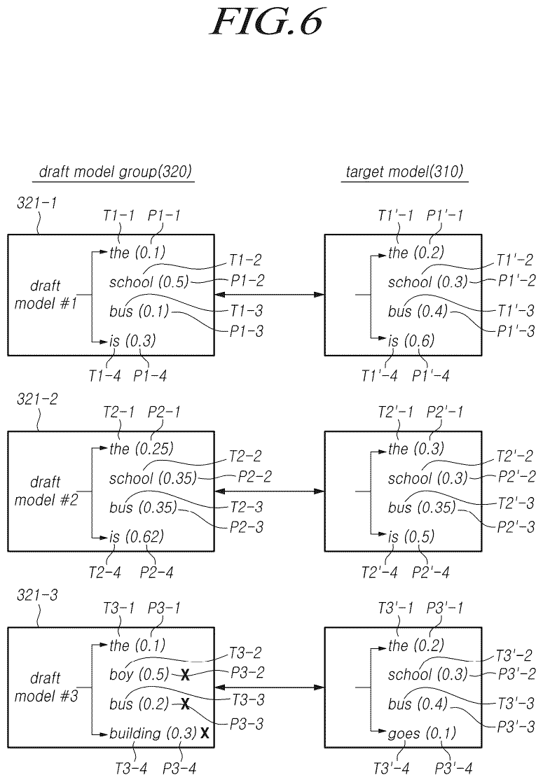

According to an example, the draft model #m 410 may generate an initial output token (hereinafter, referred to as a “first output token T_{d_out #1}”) in response to the input of the start token Ts. The first output token T_{d_out} #1 may be one of the primary output tokens (T_{d_out #1}, T_{d_out #2}, T_{d_out #3}, . . . , T_{d_out #N}) 440. The draft model #m 410 may obtain, e.g., a plurality of first candidate output tokens and probability information about the plurality of first candidate output tokens in response to the input of the start token Ts. The probability information may include, or be determined by, a probability value which is a numerical value of the probability (e.g., accuracy) that each of the plurality of first candidate output tokens obtained by the draft model #m 410 matches the information included in the prompt 250. According to an example, the draft model #m 410 may determine one first candidate output token in which the possibility to match the information included in the prompt 250, e.g., accuracy, is high among the plurality of first candidate output tokens as the first output token T_{d_out} #1 (e.g., see FIG. 6).

The draft model #m 410 may use the first output token T_{d_out} #1 as an input token (hereinafter, referred to as a “first input token T_{d_in #1}”) for predicting another token. The first input token T_{d_in} #1 may be one of the primary input tokens (T_{d_in #1}, T_{d_in #2}, T_{d_in #3}, . . . , T_{d_in #N-1}) 430. The draft model #m 410 may obtain, e.g., a plurality of second candidate output tokens and probability information about the plurality of second candidate output tokens in response to the input of the first input token T_{d_in #1}. The probability information may include, or be determined by, a probability value (e.g., q(1), q2), q(3), . . . , q(N), where N is a positive integer of 2 or more) which is a numerical value of the probability (e.g., accuracy) that each of the plurality of second candidate output tokens obtained by the draft model #m 410 matches the information included in the prompt 250. According to an example, the draft model #m 410 may determine one second candidate output token in which the possibility to match the information included in the prompt 250, e.g., accuracy, is high among the plurality of first candidate output tokens as the second output token T_{d_out #2} (e.g., see FIG. 6).

As described above, the primary output token generated before the draft model #m 410 may be used as the primary input token for generating the subsequent, next secondary output token. Further, the draft model #m 410 may generate the primary output tokens T_{d_out #3}, . . . , T_{d_out #N} based on the probability information,, for the remaining primary input tokens T_{d_in #3}, . . . , T_{d_in #N}. Accordingly, the draft model #m 410 may generate N primary output tokens (T_{d_out #1}, T_{d_out #2}, T_{d_out #3}, . . . , T_{d_out #N}) 440 corresponding to the N primary input tokens (T_{d_in #1}, T_{d_in #2}, T_{d_in #3}, . . . , T_{d_in #N-1}) 430.

The draft model #m 410 may identify, obtain, or determine the probability information (hereinafter, referred to as “first probability information 411”) corresponding to the N primary output tokens (T_{d_out #1}, T_{d_out #2}, T_{d_out #3}, . . . , T_{d_out #N}) 440. In the following, for convenience of description, probability information is described as ‘determined’, but the disclosure is not limited thereto. The draft model #m 410 may include, or determine by, the probability values q(1), q2), q(3), . . . , q(N) (where N is a positive integer of 2 or more) (hereinafter, referred to as “primary probability values”) for the primary output tokens (T_{d_out #1}, T_{d_out #2}, T_{d_out #3}, . . . , T_{d_out #N}) 440 for the first probability information 411. The primary probability values q(1), q2), q(3), . . . , q(N) may be obtained by quantifying the possibility (e.g., accuracy) that each of the primary output tokens (T_{d_out #1}, T_{d_out #2}, T_{d_out #3}, . . . , T_{d_out #N}) 440 is to match the corresponding information included in the prompt 250. For example, the primary probability values q(1), q2), q(3), . . . , q(N) may correspond to relatively the highest probability value among the candidate output tokens obtained respectively corresponding to the primary input tokens (T_{d_in #1}, T_{d_in #2}, T_{d_in #3}, . . . , T_{d_in #N-1}) 430.

The draft model #m 410 may transfer the primary output tokens (T_{d_out #1}, T_{d_out #2}, T_{d_out #3}, . . . , T_{d_out #N}) 440 to the secondary input tokens (T_{t_in #1}, T_{t_in #2}, T_{t_in #3}, . . . , T_{t_in #N}450 for the target model 420 through the corresponding token flow. For example, the primary output tokens (T_{d_out #1}, T_{d_out #2}, T_{d_out #3}, . . . , T_{d_out #N}) 440 sequentially generated by the draft model #m 410 may be sequentially input to the target model 420. For example, the primary output tokens (T_{d_out #1}, T_{d_out #2}, T_{d_out #3}, . . . , T_{d_out #N}) 440 sequentially generated by the draft model #m 410 may be simultaneously input to the target model 420 through predetermined buffering. For example, some output tokens among the primary output tokens (T_{d_out #1}, T_{d_out #2}, T_{d_out #3}, . . . , T_{d_out #N}) 440 sequentially generated by the draft model #m 410 may be sequentially input to the target model 420, and some remaining tokens may be simultaneously input to the target model 420 through predetermined buffering.

The configuration and/or operation of the draft model #m 410 may be equally applied to the remaining draft models among the plurality of draft models 321-1, 321-2, 321-3, . . . , 321-M included in the LLM 240, so that a description of the configuration and/or operation of the remaining draft models is omitted in the disclosure.

If the start token Ts is input, the target model 420 verifies the secondary input tokens (T_{t_in 2 #1}, T_{t_in #2}, T_{t_in #3}, . . . , T_{t_in #N}) 450 based on the prompt 250. The target model 420 may generate N secondary output tokens (T_{t_out #1}, T_{t_out #2}, T_{t_out #3}, . . . , T_{t_out #N}) 460 by verifying the secondary input tokens (T_{t_in #1}, T_{t_in #2}, T_{t_in #3}, . . . , T_{t_in #N}) 450. The secondary output tokens (T_{t_out #1}, T_{t_out #2}, T_{t_out #3}, . . . , T_{t_out #N}) 460 may completely match the primary output tokens (T_{d_out #1}, T_{d_out #2}, T_{d_out #3}, . . . , T_{d_out #N}) 440 (or secondary input tokens (T_{t_in #1}, T_{t_in #2}, T_{t_in #3}, . . . , T_{t_in #N}) 450) generated by the draft model #m 410. The secondary output tokens (T_{t_out #1}, T_{t_out #2}, T_{t_out #3}, . . . , T_{t_out #N}) 460 may partially match the primary output tokens (T_{d_out #1}, T_{d_out #2}, T_{d_out #3}, . . . , T_{d_out #N}) 440 (or secondary input tokens (T_{t_in #1}, T_{t_in #2}, T_{t_in #3}, . . . , T_{t_in #N}) 450) generated by the draft model #m 410. The secondary output tokens (T_{t_out #1}, T_{t_out #2}, T_{t_out #3}, . . . , T_{t_out #N}) 460 may not completely match the primary output tokens (T_{d_out #1}, T_{d_out #2}, T_{d_out #3}, . . . , T_{d_out #N}) 440 (or secondary input tokens (T_{t_in #1}, T_{t_in #2}, T_{t_in #3}, . . . , T_{t_in #N}) 450) generated by the draft model #m 410.

The target model 420 may receive the primary output tokens generated by the plurality of draft models 321-1, 321-2, 321-3, . . . , 321-M, respectively, as secondary input tokens at the same time or different times. For example, the target model 420 may generate the secondary output tokens respectively corresponding to the secondary input tokens provided from the plurality of draft models 321-1, 321-2, 321-3, . . . , 321-M and may not select draft models in which the secondary output tokens do not match the secondary input tokens (or primary output tokens) for speculative decoding. The unselected draft models may be excluded from candidates for selection as a preferred draft model. No subsequent operations may be performed on the draft models excluded from candidates for selection as a preferred draft model. In this case, one or more excluded draft models may not reside in the memory (e.g., the memory 230 of FIG. 2). For example, the excluded draft models may not use the resources of the memory 230.

According to an example, the target model 420 may obtain a plurality of candidate output tokens and probability information about the plurality of candidate output tokens for each of the secondary input tokens (T_{t_in #1}, T_{t_in #2}, T_{t_in #3}, . . . , T_{t_in #N}) 450 in response to the input of the start token Ts. The probability information may include, or be determined by, a probability value which is a numerical value of the probability (e.g., accuracy) that each of the plurality of candidate output tokens obtained for each secondary input token by the target model 420 matches the information included in the prompt 250. According to an example, the target model 420 may determine one candidate output token (e.g., a candidate output token having the highest probability value) in which the possibility, e.g., accuracy, to match the information included in the prompt 250 is relatively high among the candidate output tokens for each secondary input token as the secondary output token T_{t_out} #n corresponding to the secondary input token T_{t_in #n} (e.g., see FIG. 6). Here, n may be a natural number between 1 and N. The target model 420 may generate the secondary output tokens (T_{t_out #1}, T_{t_out #2}, T_{t_out #3}, . . . , T_{t_out #N}) 460 corresponding to the secondary input tokens (T_{t_in #1}, T_{t_in #2}, T_{t_in #3}, . . . , T_{t_in #N}) 450 input by the draft model #m 410.

The target model 420 may identify, obtain, or determine the probability information (hereinafter, referred to as “second probability information 421”) corresponding to the secondary output tokens (T_{t_out #1}, T_{t_out #2}, T_{t_out #3}, . . . , T_{t_out #N}) 460. In the following, for convenience of description, probability information is described as ‘determined’, but the disclosure is not limited thereto. The target model 420 may include, or determine by, the probability values p(1), p(2), p(3), . . . , p(N) (where N is a positive integer of 2 or more) (hereinafter, referred to as “secondary probability values”) for the secondary output tokens (T_{t_out #1}, T_{t_out #2}, T_{t_out #3}, . . . , T_{t_out #N}) 460 for the second probability information 421. The secondary probability values p(1), p(2), p(3), . . . , p(N) may be obtained by quantifying the possibility (e.g., accuracy) that each of the secondary output tokens (T_{t_out #1}, T_{t_out #2}, T_{t_out #3}, . . . , T_{t_out #N}) 460 is to match the corresponding information included in the prompt 250. For example, the secondary probability values p(1), p(2), p(3), . . . , p(N) may correspond to relatively the highest probability value among the candidate output tokens obtained respectively corresponding to the secondary input tokens (T_{t_in #1}, T_{t_in #2}, T_{t_in #3}, . . . , T_{t_in #N}) 450.

According to an example, the LLM 240 may determine the probability distribution corresponding to the draft model #m based on the primary probability values q(1), q2), q(3), . . . , q(N) of the first probability information 411 and the secondary probability values p(1), p(2), p(3), . . . , p(N) of the second probability information 421. The probability distribution may be obtained by the primary probability values q(1), q2), q(3), . . . , q(N) determined by the draft model #m 410 and the secondary probability values (p(1), p(2), p(3), . . . , p(N) determined by the target model 420 corresponding to, e.g., the same output tokens. The same output token may be an output token matching the secondary output tokens (T_{t_out #1}, T_{t_out #2}, T_{t_out #3}, . . . , T_{t_out #N}) 460 among the primary output tokens (T_{d_out #1}, T_{d_out #2}, T_{d_out #3}, . . . , T_{d_out #N}) 440 (or the secondary input tokens (T_{t_in #1}, T_{t_in #2}, T_{t_in #3}, . . . , T_{t_in #N}) 450). The LLM 240 may determine a draft model in which the probability distribution is relatively similar to the target model 420 among the plurality of draft models 321-1, 321-2, 321-3, . . . , 321-M as the preferred draft model.

According to an example, the LLM 240 may select one or more draft models in which the primary output tokens are identical to the secondary output token generated by the target model 420 among the plurality of draft models 321-1, 321-2, 321-3, . . . , 321-M. The LLM 240 may determine a draft model in which the probability distribution is relatively similar to the target model among one or more selected draft models as the preferred draft model. The probability distribution may be determined based on the primary probability values q(1), q2), q(3), . . . , q(N) and the second probability values (p(1), p(2), p(3), . . . , p(N). The primary probability values q(1), q(2), q(3), . . . , q(N) are probability values determined for the primary output tokens, respectively, in one or more selected draft models. The second probability values (p(1), p(2), p(3), . . . , p(N) are probability values determined for the secondary output tokens, respectively, in the target model 420.

According to an example, if determining the preferred draft model among the plurality of draft models 321-1, 321-2, 321-3, . . . , 321-M based on the initial specific number (e.g., N) of output tokens and the specific number of output tokens in response to the input of the prompt 250, the LLM 240 may generate the remaining tokens based on speculative decoding by taking a pair of the preferred draft model and the target model 420. If determining the preferred draft model corresponding to the prompt 250, the LLM 240 may maintain the existing model pair (e.g., the target model 420 and the preferred draft model) until all of the remaining tokens are generated.

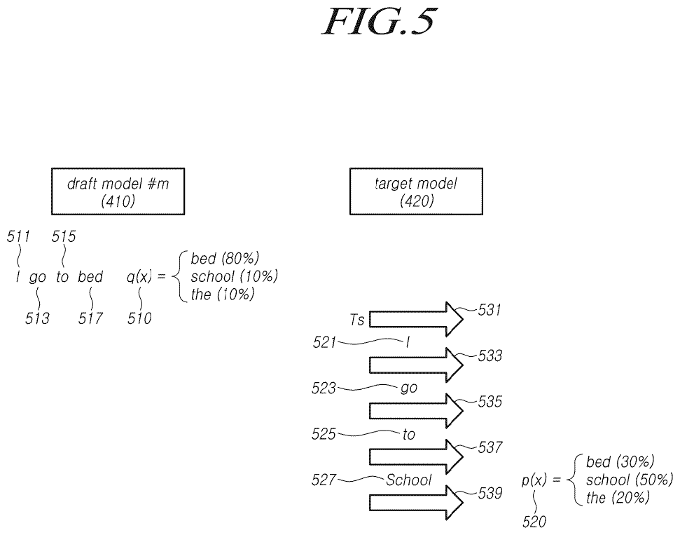

FIG. 5 is a diagram illustrating an example operation of failing to be determined as a preferred draft model as a specific draft model (e.g., the draft model #m 410 of FIG. 4) included in a plurality of draft models (e.g., the plurality of draft models 321-1, 321-2, 321-3, . . . , 321-M of FIG. 3) to be paired with a target model (e.g., the target model 310 of FIG. 3) in an electronic device (e.g., the electronic device 100 of FIG. 1) equipped with an AI model based on speculative decoding according to one or more embodiment(s). In FIG. 5, the specific draft model is an mth draft model 410 (draft model #m) included in a plurality of draft models (e.g., the plurality of draft models 321-1, 321-2, 321-3, . . . , 321-M of FIG. 3). Here, m is an integer greater than or equal to 1 (one) and less than or equal to M, and M may be an integer larger than 1 (one). The configuration and/or operation described below may be equally applied to the remaining draft models except for the draft model #m 410 among the plurality of draft models 321-1, 321-2, 321-3, . . . , 321-M.

Referring to FIG. 5, the draft model #m 410 may generate a specific number (N) (e.g., four) of consecutive output tokens (e.g., the primary output tokens (T_{d_out #1}, T_{d_out #2}, T_{d_out #3}, . . . , T_{d_out #N}) 440 based on the prompt (e.g., I go to school) (e.g., the prompt 250 of FIG. 2) corresponding to the user's input in response to the input of the start token (e.g., the start token Ts of FIG. 4). Here, m may be a natural number between 1 (one) and M. The output token generated by the draft model #m 410 may be referred to as a ‘preferred output token.’ For example, the draft model #m 410 generates the first output token “I 511” using the start token Ts as the first input token, generates the second output token “go 513” using the first output token “I 511” as the second input token, generates the third output token “to 515” using the second output token “go 513” as the third input token, and generates the fourth output token “bed 517” using the third output token “to 515” as the fourth input token. Thus, the specific number of output tokens may be ‘I 511’, ‘go 513’, ‘to 515’, and ‘bed 517’.

According to an example, if the start token Ts is input, the draft model #m 410 may obtain at least one candidate output token predicted as the first token based on the prompt 250 and determine a preferred output token among the at least one candidate token. The draft model #m 410 may determine, e.g., a probability value for the at least one candidate output token and a preferred output token based on the determined probability value. The probability value may be a numerical value of the possibility (e.g., accuracy) that each of the at least one candidate output token is to match the corresponding information included in the prompt 250. The draft model #m 410 may determine the candidate output token having the highest probability value among the at least one candidate output token as the preferred output token. For example, the draft model #m 410 may obtain “bed”, “school”, and “the” as candidate output tokens using the third-generated output token ‘to’ 515 as the input token. The draft model #m 410 may determine “80%,” “10%,” and “10%” as the probability value (q(x)) 510 corresponding to “bed”, “school”, and “the”, respectively, which are the obtained output tokens. The draft model #m 410 may determine “bed” which has the highest probability value (q(x)) 510 among “bed,” “school,” and “the” which are the obtained candidate output tokens as the preferred output token. Although an example in which a preferred output token is determined corresponding to one input token is described here, it may be determined in the same manner for the remaining preferred output tokens “I,” “go,” or “to.”

The target model 420 may perform a verification operation on a specific number (N) (e.g., four) of output tokens generated for each of the plurality of draft models 321-1, 321-2, 321-3, . . . , 321-M in response to the input of the start token (e.g., the start token Ts of FIG. 4). For example, the target model 420 may perform the verification process of generating N tokens having the highest probability by calculating the correlation between the initial token and the N input tokens provided by each draft models 321-1, 321-2, 321-3, . . . , 321-M and correlation between the N input tokens. For example, the target model 420 may perform the verification process on each of the draft models 321-1, 321-2, 321-3, . . . , 321-M. In the following description, the target model 420 performs a verification operation on one draft model (e.g., the mth draft model 410, where m is a natural number between 1 and M), but substantially the same verification operation may be performed on the remaining draft models.

According to an example, the target model 420 may generate output tokens corresponding to the tokens output from the plurality of draft models 321-1, 321-2, 321-3, . . . , 321-M and input in a batch manner. The target model 420 may generate second output tokens using the first output tokens generated by the draft model as input tokens.

According to an example, the target model 420 may generate respectively corresponding preferred output tokens 531, 533, 535, 537, and 539 using the start token Ts and “I 511”, “go 513”, “to 515”, or “bed 517” generated by the draft model #m 410 as input tokens 521, 523, 525, and 527. The preferred output tokens generated by the target model 420 may be, e.g., “I 531”, “go 533”, “to 535”, “school 537”, and “. 539”. The target model 420 may determine output token probabilities p(“I”), p(“go”), p(“to”), p(“bed”), p(“.”) respectively corresponding to the preferred output tokens 531, 533, 535, 537, and 539. For example, the target model 420 may determine “30%”, “50%”, and “20%” as the probability value (p(x)) 520 corresponding to “bed”, “school”, and “the”, respectively, which are the candidate output tokens obtained for the input token “to 525”.

Since the input tokens “I 511,” “go 513,” “to 515,” and “bed 517” of the target model 420 do not match the output tokens “I 521,” “go 523,” “to 525,” and “school 527” of the target model 420, the draft model #m 410 may be excluded from selection as a preferred draft model. However, when the input tokens and output tokens of the target model 420 match as “I 521,” “go 523,” “to 525,” and “school 527,” the draft model #m 410 may be a candidate that may be selected as a preferred draft model.

As described above, all of the tokens generated from each of the target model 420 and the plurality of draft models 321-1, 321-2, 321-3, . . . , 321-M may have probability values, respectively. The probability values of the tokens for each draft model obtained by the target model 420 and the probability values of the tokens obtained from the corresponding model may be compared, and the draft model having the largest number of same tokens may be selected. The probability distribution sum for the selected draft model may be obtained for each draft model. A draft model having the smallest difference between the probability distribution sum obtained for each draft model and the probability distribution sum obtained by the target model 420 (e.g., various matrixes are applicable such as square difference or absolute value difference) may be determined as the preferred draft model.

FIG. 6 is a diagram illustrating an example operation of determining a preferred draft model to be paired with a target model (e.g., the target model 310 of FIG. 3) in a draft model group (e.g., the draft model group 320 of FIG. 3) in an electronic device (e.g., the electronic device 100 of FIG. 1) equipped with an AI model (e.g., the LLM 240 of FIG. 2) based on speculative decoding according to one or more embodiment(s). In FIG. 6, the draft model group 320 includes three draft models (e.g., the draft model #1 321-1, the draft model #2 321-2, and the draft model #3 321-3 of FIG. 3). The draft model group 320 may be, e.g., a set of target draft models that may be determined as preferred draft models. The configuration and/or operation described below may be equally applied to the remaining draft models that are not included in the draft model group 320 but are included in the plurality of draft models 321-1, 321-2, 321-3, . . . , 321-M.

Referring to FIG. 6, the draft model #1 321-1 consecutively obtain “the,” “school,” “bus,” and “is” which are four output tokens T1-1, T1-2, T1-3, and T1-4 corresponding to the prompt (e.g., “The school bus is ˜”). The draft model #1 321-1 may determine the first probability values P1-1, P1-2, P1-3, and P1-4 respectively corresponding to the obtained output tokens “the,” “school,” “bus,” and “is” as “0.1,” “0.5,” “0.1,” and “0.3.”

The target model 310 may obtain “the,” “school,” “bus,” and “is” which are four output tokens T1′-1, T′1-2, T′1-3, and T1′-4 using “the,” “school,” “bus,” and “is” which are the tokens T1-1, T1-2, T1-3, and T1-4 output by the draft model #1 321-1 as inputs. Since the output tokens generated by the draft model #1 321-1 and the output tokens generated by the target model 310 match each other, the target model 310 may determine the draft model #1 321-1 as a candidate that may be selected as a preferred draft model. The target model 310 may determine probability values P1′-1, P1′-2, P1′-3, and P1′-4, respectively corresponding to the output tokens “the,” “school,” “bus,” and “is,” which are generated using the output tokens of the draft model #1 321-1 as inputs, as “0.2,” “0.3,” “0.4,” and “0.6.”

The draft model #2 321-2 consecutively obtain “the,” “school,” “bus,” and “is” which are four output tokens T2-1, T2-2, T2-3, and T2-4 corresponding to the prompt (e.g., “The school bus is ˜”). The draft model #2 321-2 may determine the first probability values P2-1, P2-2, P2-3, and P2-4 respectively corresponding to the obtained output tokens “the,” “school,” “bus,” and “is” as “0.25,” “0.35,” “0.35,” and “0.62.”

The target model 310 may obtain “the,” “school,” “bus,” and “is” which are four output tokens T2′-1, T'2-2, T'2-3, and T2′-4 using “the,” “school,” “bus,” and “is” which are the tokens output by the draft model #2 321-2 as inputs. Since the output tokens generated by the draft model #2 321-2 and the output tokens generated by the target model 310 match each other, the target model 310 may determine the draft model #2 321-2 as a candidate that may be selected as a preferred draft model. The target model 310 may determine probability values P2′-1, P2′-2, P2′-3, and P2′-4, respectively corresponding to the output tokens “the,” “school,” “bus,” and “is,” which are generated using the output tokens of the draft model #2 321-2 as inputs, as “0.3,” “0.3,” “0.35,” and “0.5.”

The draft model #3 321-3 consecutively obtain “the,” “boy,” “bus,” and “building” which are four output tokens T3-1, T3-2, T3-3, and T3-4 corresponding to the prompt (e.g., “The school bus is ˜”). The draft model #3 321-3 may determine the first probability values P3-1, P3-2, P3-3, and P3-4 respectively corresponding to the obtained output tokens “the,” “boy,” “bus,” and “building” as “0.1,” “0.5,” “0.2,” and “0.3.”

The target model 310 may obtain “the,” “boy,” “bus,” and “building” which are four output tokens T3′-1, T′3-3, T′3-3, and T3′-4 using “the,” “boy,” “bus,” and “building” which are the tokens output by the draft model #3 321-3 as inputs. Since the output tokens generated by the draft model #3 321-3 and the output tokens generated by the target model 310 do not match each other, the target model 310 may determine to exclude the draft model #3 321-3 from the preferred draft models. The target model 310 may determine probability values P3′-1, P3′-2, P3′-3, and P3′-4, respectively corresponding to the output tokens “the,” “school,” “bus,” and “goes,” which are generated using the output tokens of the draft model #3 321-3 as inputs, as “0.3,” “0.3,” “0.4,” and “0.1.”

The electronic device 100 may include a predetermined component to perform a function of determining a preferred draft model among the three draft models (e.g., draft model #1 321-1, draft model #2 321-2, and draft model #3 321-3). The predetermined component may be, e.g., an LLM (e.g., the LLM 240 of FIG. 2). The predetermined component may be, e.g., a specific function module included in the LLM 240. The predetermined component may be a specific function module by a combination of at least one or more of a CPU (e.g., the CPU 211 of FIG. 2), an NPU (e.g., the NPU 213 of FIG. 2), or a GPU (e.g., the GPU 215 of FIG. 2)) capable of processing other than the LLM 240 in the electronic device 100.

According to an example, the predetermined component may perform a verification process of comparing the probability values of “the,” “school,” “bus,” and “is,” which are the same tokens output from the target model 310 and the plurality of candidate draft models (e.g., the draft model #1 321-1 and draft model #2 321-2) in speculative decoding. The plurality of candidate draft models may be, e.g., the draft model #1 321-1 and the draft model #2 321-2 that generate the same output tokens as the target model 310 among the three draft models 321-1, 321-2, and 321-3.

For example, the verification operation for the draft model #1 321-1 may obtain 0.23 which is the sum (\textcircled{1}+\textcircled{2}+\textcircled{3}+\textcircled{4}) of the respective squares ^{(\textcircled{1})} (0.2−0.1)², ^{\textcircled{2}} (0.3−0.5)², ^{\textcircled{3}} (0.4−0.1)², ^{\textcircled{4}} (0.6−0.3)²) of the difference values between “0.1,” “0.5,” “0.1,” and “0.3” which are the probability values P1-1, P1-2, P1-3, and P1-4 determined for “the,” “school,” “bus,” and “is,” respectively, which are the same output tokens T1-1, T1-2, T1-3, and T1-4 by the draft model #1 321-1 and “0.2,” “0.3,” “0.4,” and “0.6” which are the probability values P1′-1, P1′-2, P1′-3, and P1′-4 determined for “the,” “school,” “bus,” and “is,” respectively, which are the same output tokens T1′-1, T1′-2, T1′-3, and T1′-4 by the target model 310 as the probability distribution corresponding to the draft model #1 321-1.

For example, the verification operation for the draft model #2 321-2 may obtain 0.0194 which is the sum (\textcircled{1}+\textcircled{2}+\textcircled{3}+\textcircled{4}) of the respective squares (^{\textcircled{1}} (0.3−0.25)², ^{\textcircled{2}} (0.3−0.35)², ^{\textcircled{3}} (0.35−0.35)², ^{\textcircled{4}} (0.5−0.62)²) of the difference values between “0.25,” “0.35,” “0.35,” and “0.62” which are the probability values P2-1, P2-2, P2-3, and P2-4 determined for “the,” “school,” “bus,” and “is,” respectively, which are the same output tokens T2-1, T2-2, T2-3, and T2-4 by the draft model #2 321-2 and “0.3,” “0.3,” “0.35,” and “0.5” which are the probability values P2′-1, P2′-2, P2′-3, and P2′-4 determined for “the,” “school,” “bus,” and “is,” respectively, which are the same output tokens T2′-1, T2′-2, T2′-3, and T2′-4 by the target model 310 as the probability distribution corresponding to the draft model #2 321-2.

For example, the verification operation for the draft model #2 321-2 may determine the candidate draft model having the smallest probability distribution difference among the probability distributions obtained for the plurality of candidate draft models as the preferred draft model. If the probability distribution is small, it may be determined that the corresponding draft model is most similar to the target model 310. In the above embodiments, since ‘0.0194,’ which is the probability distribution corresponding to the draft model #2 321-2, has a relatively small value as compared with ‘0.23,’ which is the probability distribution corresponding to the draft model #1 321-1, the draft model #2 321-2 and the target model 310 may be paired to perform speculative decoding operation.

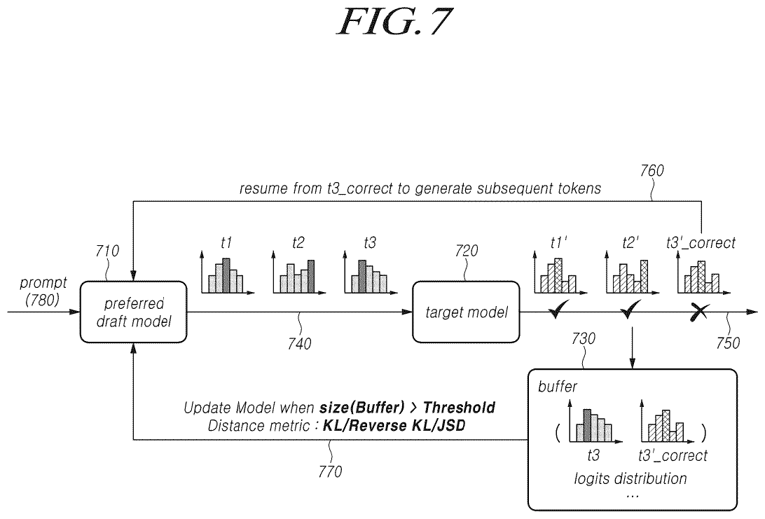

FIG. 7 is a diagram illustrating an example operation of generating tokens based on speculative decoding with a preferred draft model determined from a plurality of draft models (e.g., the plurality of draft models 321-1, 321-2, 321-3, . . . , 321-M of FIG. 3) and a target model (e.g., the target model 310 of FIG. 3) paired in an electronic device (e.g., the electronic device 100 of FIG. 1) according to one or more embodiment(s).

Referring to FIG. 7, the preferred draft model 710 may use the target model 720 and the same prompt 780 (e.g., the prompt 250 of FIG. 2) corresponding to the user input as inputs. The preferred draft model 710 may be determined by a specific number (e.g., M) of initial tokens generated by the plurality of draft models 321-1, 321-2, 321-3, . . . , 321-M and the probability value of the initial tokens.

The preferred draft model 710 may generate a specific number of tokens t1, t2, and t3 in succession to the initial tokens based on the prompt 250. In this case, the number of tokens generated by the preferred draft model 710 may be equal to or different from the number M of the initial tokens. Since the operation of generating the specific number of tokens t1, t2, and t3 by the preferred draft model 710 is substantially the same as the operation for generating the initial tokens, an additional description thereof is omitted. The preferred draft model 710 may provide the generated tokens t1, t2, and t3 as inputs of the target model 720 (operation 740).

The target model 720 may generate tokens t1′, t2′, and t3′ corresponding to tokens t1, t2, and t3 input by the preferred draft model 710. The tokens t1, t2, and t3 generated by the preferred draft model 710 may be verified by comparison with the tokens t1′, t2′, and t3′ generated by the target model 720. If among the tokens t1, t2, and t3 generated by the preferred draft model 710, there is a token that does not match the tokens t1′, t2′, and t3′ generated by the target model 720, the corresponding token (e.g., t3) may be corrected to a token (e.g., the t3′_correct) predicted to be accurate (operation 750).

The information related to the error correction may be managed by the buffer 730. If the buffer size exceeds a threshold level, the buffer 730 may request to update the preferred draft model 710 (operation 770).

The information related to the error correction may be provided to the preferred draft model 710 (operation 760). The information related to the error correction may include a target token to be corrected and/or token information to be corrected. The preferred draft model 710 may perform correction on the corresponding token based on information related to the error correction. The preferred draft model 710 may resume generation of consecutive tokens using the error-corrected token as a new input token.

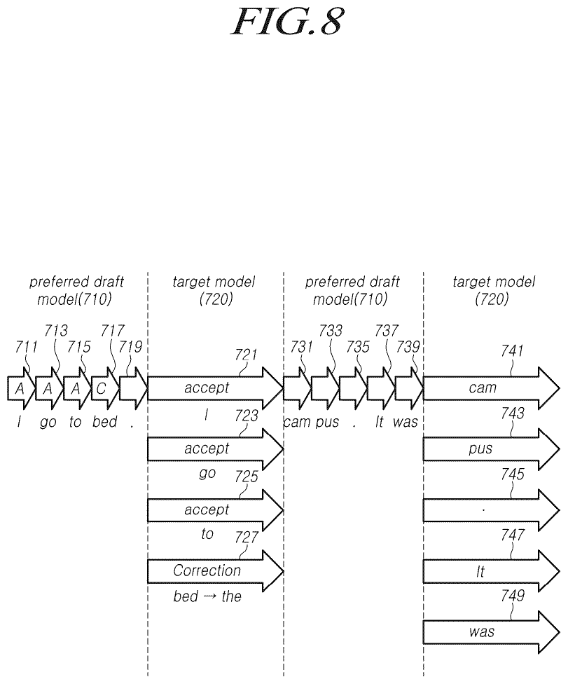

FIG. 8 is an diagram illustrating an example operation of generating tokens based on speculative decoding in an electronic device (e.g., the electronic device 100 of FIG. 1) according to one or more embodiment(s).

Referring to FIG. 8, the preferred draft model 710 may use the target model 720 and the same prompt (e.g., the prompt 250 of FIG. 2) corresponding to the user input as inputs. The preferred draft model 710 may be determined by a specific number (e.g., M) of initial tokens generated by the plurality of draft models 321-1, 321-2, 321-3, . . . , 321-M and the probability value of the initial tokens.

The preferred draft model 710 may generate a specific number (e.g., five) of tokens 711, 713, 715, 717, and 719 (e.g., “I,” “go,” “to,” “bed,” and “.”) based on the prompt 250 and transmit the same to the target model 720. The target model 720 may perform verification (721, 723, 725, and 727) on a specific number (e.g., five) of tokens 711, 713, 715, 717, and 719 (e.g., the “I,” “go,” “to, “bed,” and “.”) input from the preferred draft model 710 and recognize that error correction is required for “bed,” which is one token 717 of the specific number (e.g., five) tokens 711, 713, 715, 717, and 719. The target model 720 may request the preferred draft model 710 to correct “bed,” which is the token 717 with an error, to “the.”

The preferred draft model 710 may correct “bed,” which is the last token 717, to “the” based on the information related to the error correction. The preferred draft model 710 may generate consecutive tokens using the error-corrected token as a new input token and input the same to the target model 720.

The preferred draft model 710 may generate a specific number (e.g., five) of tokens 731, 733, 735, 737, and 739 (e.g., “cam,” “pus,” “.”, “It,” and “was”) consecutive to the token (e.g., the corrected token “the”) input to the target model 720 before based on the prompt 250 and transmit the same to the target model 720. The target model 720 may perform verification (741, 743, 743, 745, 747, and 749) on a specific number (e.g., five) of tokens 731, 733, 735, 737, and 739 (e.g., “cam,” “pus,” “.”, “It,” and “was”) input from the preferred draft model 710.

The preferred draft model 710 and the target model 720 of the pair may perform a speculative decoding operation until generation (e.g., execution) of all tokens corresponding to the prompt 250 is completed.

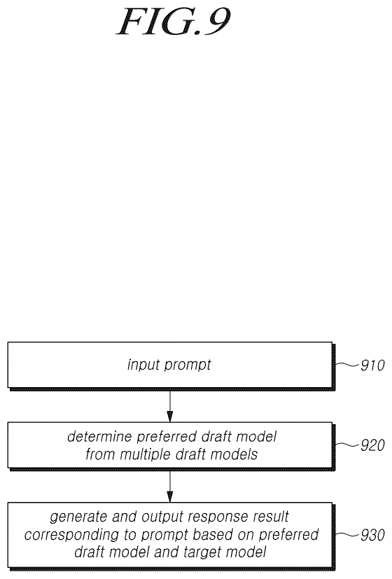

FIG. 9 is a flowchart illustrating example operations for performing speculative decoding in an electronic device (e.g., the electronic device 100 of FIG. 1) according to one or more embodiment(s).

Referring to FIG. 9, in operation 910, the electronic device 100 may receive a prompt (e.g., the prompt 250 of FIG. 2) inputted by the user. The prompt 250 may be, e.g., a command or a query that the user transmits to the LLM 240 for a conversation with an LLM (e.g., the LLM 240 of FIG. 2) mounted on the electronic device 100. For example, the prompt 250 may serve as a communication window between the user and the LLM 240. The LLM 240 mounted on the electronic device 100 should be able to accurately analyze or understand the prompt 250 in order to provide accurate information desired by the user. The prompt 250 may include a plurality of draft models (e.g., the plurality of draft models 321-1, 321-2, 321-3, . . . , 321-M of FIG. 3) and at least one target model (e.g., the target model 310 of FIG. 3) included in the LLM 240. The target model 310 may have a large size relative to the plurality of draft models 321-1, 321-2, 321-3, . . . , 321-M. The plurality of draft models 321-1, 321-2, 321-3, . . . , 321-M may have different sizes.

In operation 920, the electronic device 100 may determine a preferred draft model to be used for speculative decoding among the plurality of draft models 321-1, 321-2, 321-3, . . . , 321-M. According to an example, the electronic device 100 may be operated so that the plurality of draft models 321-1, 321-2, 321-3, . . . , 321-M obtain a specific number (N) (e.g., four) of consecutive output tokens based on the prompt 250 in response to the start token. The start token may be generated by the target model 310 in response to the input of the prompt. The electronic device 100 may be operated to identify first probability information which is a numerical value of the possibility (e.g., accuracy) that the first output tokens obtained for each draft model are to match the information included in the prompt 250 in the plurality of draft models 321-1, 321-2, 321-3, . . . , 321-M.

The electronic device 100 may be operated so that the target model 310 obtains second output tokens for each draft model using the first output tokens as inputs. For example, the second output tokens may be at least partially identical to the first output tokens. The second output tokens may be substantially identical to the second output tokens, for example.

The electronic device 100 may be operated to identify second probability information which is a numerical value of the possibility (e.g., accuracy) that the second output tokens obtained for each draft model are to match the information included in the prompt 250 in the target model 310. The electronic device 100 may be operated to determine a draft model in which the first probability information is relatively similar to the second probability information as compared with one or more other draft models among the plurality of draft models 321-1, 321-2, 321-3, . . . , 321-M, as the preferred draft model.

According to an example, the electronic device 100 may be operated to determine a draft model in which the probability distribution is similar to the target model 310 among the plurality of draft models 321-1, 321-2, 321-3, . . . , 321-M as the preferred draft model. The probability distribution may be probability information determined by the probability value of the same output tokens (hereinafter, referred to as “third output tokens”) included in both the first output tokens and the second output tokens corresponding to the plurality of draft models 321-1, 321-2, 321-3, . . . , 321-M, respectively. As an example, the probability distribution may be obtained by squaring the difference between the first probability value and the second probability values and summating the squares calculated corresponding to the third output tokens. The first probability value may be determined for each of the third output tokens by the corresponding draft model. The second probability value may be determined for each of the third output tokens by the target model 310. For example, if determined that there is a plurality of preferred draft models, the electronic device 100 may be operated to select a draft model having a relatively small size among the plurality of preferred draft models. For example, if determined that there is a plurality of preferred draft models, the electronic device 100 may be operated to select one among the plurality of preferred draft models considering the state information about the electronic device 100. The state information may include information indicating the heat generation state and/or battery charging state.

According to an embodiment, the electronic device 100 may be operated to select, as at least one candidate draft model, one or more draft models in which the output tokens are identical to those of the target model 310 among the plurality of draft models 321-1, 321-2, 321-3, . . . , 321-M. The electronic device 100 may be operated to determine a draft model in which the probability distribution is similar to that of the target model 310 among the selected at least one candidate draft model as the preferred draft model. The probability distribution may be probability information determined by the probability values determined by at least one candidate draft model selected for the third output tokens and the probability values determined by the target model 310. As an example, the probability distribution may be obtained by squaring the difference between the first probability value and the second probability values and summating the squares calculated corresponding to the third output tokens. The first probability value may be determined for each of the third output tokens by the corresponding draft model. The second probability value may be determined for each of the third output tokens by the target model 310. For example, if determined that there is a plurality of preferred draft models, the electronic device 100 may be operated to select a draft model having a relatively small (or smallest) size from the plurality of preferred draft models. For example, if determined that there is a plurality of preferred draft models, the electronic device 100 may be operated to select one among the plurality of preferred draft models taking into consideration the state information of the electronic device 100. The state information may include information indicating the heat generation state or battery charging state.

In operation 930, the electronic device 100 may be operated to generate the remaining tokens corresponding to the prompt 250 based on the speculative decoding scheme using the determined preferred draft model and the target model 310 as a pair. For example, the electronic device 100 may be operated to verify the remaining tokens based on the prompt 250 in units of a specific number of tokens, using the preferred draft model and the target model 310 as one pair after determining the preferred draft model. In operation 930, the electronic device 100 may be operated to generate a result value responsive to the prompt 250 based on the verification result for all output tokens corresponding to the prompt 250. The electronic device 100 may be operated to output the generated result value. The result value output by the electronic device 100 may be identified by the user.

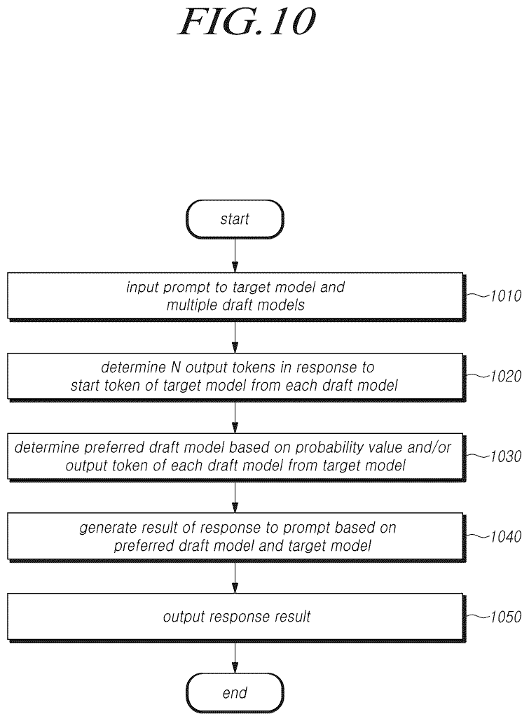

FIG. 10 is a flowchart illustrating example operations for driving a generative AI model in an electronic device (e.g., the electronic device 100 of FIG. 1) according to one or more embodiment(s).

Referring to FIG. 10, in operation 1010, the electronic device 100 may be operated to input a prompt (e.g., the prompt 250 of FIG. 2) input, for example, by the user to a plurality of draft models (e.g., the plurality of draft models 321-1, 321-2, 321-3, . . . , 321-M of FIG. 3) and at least one target model (e.g., the target model 310 of FIG. 3) included in the LLM 240. The target model 310 may have a large size relative to the plurality of draft models 321-1, 321-2, 321-3, . . . , 321-M. The plurality of draft models 321-1, 321-2, 321-3, . . . , 321-M may have different sizes. The prompt 250 may be, e.g., a command or a query that the user transmits to the LLM 240 for a conversation with an LLM (e.g., the LLM 240 of FIG. 2) mounted on the electronic device 100. For example, the prompt 250 may serve as a communication window between the user and the LLM 240. Therefore, to accurately provide desired information, the electronic device 100 needs to implement the LLM 240 to be able to accurately analyze or understand the prompt 250.

In operation 1020, the electronic device 100 may be operated so that each of the plurality of draft models 321-1, 321-2, 321-3, . . . , 321-M generates a specific number (e.g., N) of consecutive first output tokens based on the prompt 250 in response to the start token generated by the target model 310. For example, the consecutive output tokens generated by the plurality of draft models 321-1, 321-2, 321-3, . . . , 321-M, respectively, are as shown in FIG. 6. The start token may be generated by the target model 310 in response to the input of the prompt 250. The electronic device 100 may be operated to identify first probability information which is a numerical value of the possibility (e.g., accuracy) that the first output tokens obtained for each draft model are to match the information included in the prompt 250 in the plurality of draft models 321-1, 321-2, 321-3, . . . , 321-M.

In operation 1030, the electronic device 100 may be operated so that the target model 310 obtains second output tokens for each draft model using the first output tokens as inputs. For example, the second output tokens may be at least partially identical to the first output tokens. The second output tokens may be substantially identical to the second output tokens, for example. The electronic device 100 may be operated to identify second probability information which is a numerical value of the possibility (e.g., accuracy) that the second output tokens obtained for each draft model are to match the information included in the prompt 250 in the target model 310.

In operation 1030, the electronic device 100 may determine one draft model included in the plurality of draft models 321-1, 321-2, 321-3, . . . , 321-M as a preferred draft model based on the first probability information and the second probability information. For example, the electronic device 100 may be operated to determine a draft model in which the first probability information is relatively similar to the second probability information as compared with one or more other draft models, as the preferred draft model.

According to an example, the electronic device 100 may be operated to determine a draft model in which the probability distribution is similar to the target model 310 among the plurality of draft models 321-1, 321-2, 321-3, . . . , 321-M as the preferred draft model. The probability distribution may be probability information determined by the probability value of the same output tokens (hereinafter, referred to as “third output tokens”) included in both the first output tokens and the second output tokens corresponding to the plurality of draft models 321-1, 321-2, 321-3, . . . , 321-M, respectively. As an example, the probability distribution may be obtained by squaring the difference between the first probability value and the second probability values and summating the squares calculated corresponding to the third output tokens. The first probability value may be determined for each of the third output tokens by the corresponding draft model. The second probability value may be determined for each of the third output tokens by the target model 310. For example, if determined that there is a plurality of preferred draft models, the electronic device 100 may be operated to select a draft model having a relatively small size among the plurality of preferred draft models. For example, if determined that there is a plurality of preferred draft models, the electronic device 100 may be operated to select one among the plurality of preferred draft models considering the state information about the electronic device 100. The state information may include information indicating the heat generation state or battery charging state.

According to an embodiment, the electronic device 100 may be operated to select, as at least one candidate draft model, one or more draft models in which the output tokens are identical to those of the target model 310 among the plurality of draft models 321-1, 321-2, 321-3, . . . , 321-M. The electronic device 100 may be operated to determine a draft model in which the probability distribution is similar to that of the target model 310 among the selected at least one candidate draft model as the preferred draft model. The probability distribution may be probability information determined by the probability values determined by at least one candidate draft model selected for the third output tokens and the probability values determined by the target model 310. As an example, the probability distribution may be obtained by squaring the difference between the first probability value and the second probability values and summating the squares calculated corresponding to the third output tokens. The first probability value may be determined for each of the third output tokens by the corresponding draft model. The second probability value may be determined for each of the third output tokens by the target model 310. For example, if determined that there is a plurality of preferred draft models, the electronic device 100 may be operated to select a draft model having a relatively small size among the plurality of preferred draft models. For example, if determined that there is a plurality of preferred draft models, the electronic device 100 may be operated to select one among the plurality of preferred draft models considering the state information about the electronic device 100. The state information may include information indicating the heat generation state or battery charging state.

According to an example, when there are a plurality of draft models in which the probability distribution is identical or similar to the target model 310 among the plurality of draft models 321-1, 321-2, 321-3, . . . , 321-M, the electronic device 100 may determine a draft model having more tokens identical to those of the target model 310 as a preferred draft model regardless of the difference in probability distribution.

In operation 1040, the electronic device 100 may be operated to generate the remaining tokens corresponding to the prompt 250 based on the speculative decoding scheme using the determined preferred draft model and the target model 310 as a pair. For example, the electronic device 100 may be operated to verify the remaining tokens based on the prompt 250 in units of a specific number of tokens, using the preferred draft model and the target model 310 as one pair after determining the preferred draft model. The electronic device 100 may be operated to generate a result value responsive to the prompt 250 based on the verification result for all output tokens corresponding to the prompt 250.

In operation 1050, the electronic device 100 may be operated to output the generated result value. The result value output by the electronic device 100 may be identified by the user.

According to an example, the electronic device 100 may determine whether there is a prompt identical or similar to the input prompt among the prompts in which a response result has been output by the driving of the generative AI model performed before. If there is a corresponding prompt identical or similar to the input prompt, the electronic device 100 may determine the draft model used for speculative decoding on the corresponding prompt as a preferred draft model for speculative decoding on the input prompt.

According to an example, if a plurality of prompts are input, the electronic device 100 may omit the operation of determining the preferred draft model and simultaneously process the plurality of prompts using a preset draft model.

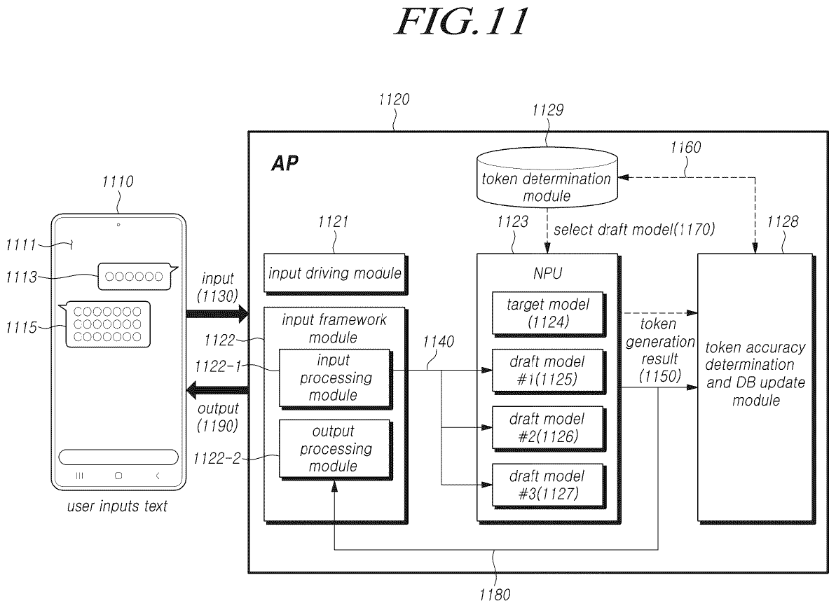

FIG. 11 is a diagram illustrating an example configuration for driving a generative AI model in an electronic device (e.g., the electronic device 100 of FIG. 1) according to one or more embodiment(s).

Referring to FIG. 11, in the electronic device 100, at least one processor (e.g., an AP) (e.g., including processing circuitry) 1120 may include an input driving module (e.g., including various circuitry and/or executable program instructions) 1121, an input framework module 1122, an NPU (e.g., including processing circuitry) 1123, a token accuracy determination and BD update module 1128, and/or a token determination module 1129 for driving the generative AI model. The input framework module 1122 may include an input processing module 1122-1 or an output processing module 1122-2, each of which may include various processing circuitry. The NPU 1123 may include at least one target model 1124 (e.g., the target model 310 of FIG. 3) or a plurality of draft models (e.g., the plurality of draft models 321-1, 321-2, 321-3, . . . , 321-M of FIG. 3). The NPU 1123 may include, e.g., a draft model #1 1125, a draft model #2 1126, or a draft model #3 1127.

The electronic device 100 may include a display 1110. The display 1110 may display a screen 1111 for a conversation with the user. The user may input a prompt (e.g., the prompt 250 of FIG. 2) corresponding to a command or query to be transferred to the LLM 240 for a conversation with the LLM (e.g., the LLM 240 of FIG. 2) operating on the AP 1120 through the screen 1111 (reference number 1113). The display 1110 may be controlled by the input driving module 1121 included in the AP 1120. The prompt 250 corresponding to the user's input may be input to the input processing module 1122-1 included in the input framework module 1122 under the control of the input driving module 1121 (1130).

The input processing module 1122-1 may convert a prompt, which is a natural language such as voice and/or text, into a machine language that may be recognized inside the electronic device 100.

The NPU 1123 may receive 1140 the machine language converted by the input processing module 1122-1 and analyze the prompt 250 converted into the machine language to generate tokens. The NPU 1123 may generate tokens corresponding to the prompt 250 based on a speculative decoding method.

According to an example, each of the draft model #1 1125, the draft model #2 1126, and the draft model #3 1127 included in the NPU 1123 may obtain a specific number (e.g., N) of consecutive first output tokens in response to the input of a start token based on the prompt 250. The start token may be generated by the target model 1124 in response to the input of the prompt 250. Each of the draft model #1 1125, the draft model #2 1126, and the draft model #3 1127 may determine first probability information which is a numerical value of the possibility (e.g., accuracy) that the first output tokens are to match the information included in the prompt 250. Each of the draft model #1 1125, the draft model #2 1126, and the draft model #3 1127 may input the first output tokens and/or the first probability information determined corresponding to the first output tokens, respectively, to the target model 1124.

The target model 1124 may obtain second output tokens for each draft model based on the prompt 250 using the first output tokens for each draft model generated by each of the draft model #2 1126, the draft model #2 1126, and the draft model #3 1127. The target model 1124 may determine second probability information which is a numerical value of the possibility (e.g., accuracy) that the second output tokens for each draft model are to match the information included in the prompt 250.

The target model 1124 may provide information 1150 about the token generation result to the token accuracy determination and DB update module 1128. The information 1150 about the token generation result may include first output tokens for each draft model and first probability information, and second output tokens for each draft model and second probability information. Information 1150 about the token generation result may also be provided to the output processing module 1122-2 included in the input framework module 1122 (1180). The output processing module 1122-2 may output information 1150 about the token generation result as a processing result corresponding to the input 1130 (1190 ). The display 1110 may display a processing result on the screen 1111 based on the output 11190 of the output processing module 1122-2 (1115).

The token accuracy determination and DB update module 1128 may analyze the information 1150 about the token generation result to determine the accuracy of the first output tokens for each draft model. The token accuracy determination and DB update module 1128 may update the related data of the DB based on the determined accuracy of the first output tokens for each draft model. The token accuracy determination and DB update module 1128 may provide information 1160 about the determined accuracy of the first output tokens for each draft model to the token determination module 1129.

The token determination module 1129 may select one of the draft model #1 1125, the draft model #2 1126, and the draft model #3 1127 as the preferred draft model based on information about the determined accuracy of the first output tokens for each determined draft model provided from the token accuracy determination and the DB update module 1128.

The draft model selected as the preferred draft model by the token determination module 1129 among the draft model #1 1125, the draft model #2 1126, and the draft model #3 1127 may pair with the target model 1124 to generate or analyze the remaining tokens based on a speculative decoding method.

FIG. 12 is a block diagram illustrating an example electronic device 1201 (e.g., the electronic device 100 of FIG. 1) in a network environment 1200 according to one or more embodiment(s).

Referring to FIG. 12, the electronic device 1201 in the network environment 1200 may communicate with at least one of an electronic device 1202 via a first network 1298 (e.g., a short-range wireless communication network), or an electronic device 1204 or a server 1208 via a second network 1299 (e.g., a long-range wireless communication network). According to an embodiment, the electronic device 1201 may communicate with the electronic device 1204 via the server 1208. According to an embodiment, the electronic device 1201 may include a processor 1220, memory 1230, an input module 1250, a sound output module 1255, a display module 1260, an audio module 1270, a sensor module 1276, an interface 1277, a connecting terminal 1278, a haptic module 1279, a camera module 1280, a power management module 1288, a battery 1289, a communication module 1290, a subscriber identification module (SIM) 1296, or an antenna module 1297. In an embodiment, at least one (e.g., the connecting terminal 1278) of the components may be omitted from the electronic device 1201, or one or more other components may be added in the electronic device 101. According to an embodiment, some (e.g., the sensor module 1276, the camera module 1280, or the antenna module 1297) of the components may be integrated into a single component (e.g., the display module 1260).

The processor 1220 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 1220 may execute, for example, software (e.g., a program 1240) to control at least one other component (e.g., a hardware or software component) of the electronic device 1201 coupled with the processor 1220, and may perform various data processing or computation. According to an embodiment, as at least part of the data processing or computation, the processor 1220 may store a command or data received from another component (e.g., the sensor module 1276 or the communication module 1290) in volatile memory 1232, process the command or the data stored in the volatile memory 1232, and store resulting data in non-volatile memory 1234. According to an embodiment, the processor 1220 may include a main processor 1221 (e.g., a CPU or an AP), or an auxiliary processor 1223 (e.g., a GPU, a NPU, an ISP, a sensor hub processor, or a CP) that is operable independently from, or in conjunction with, the main processor 121. For example, when the electronic device 1201 includes the main processor 1221 and the auxiliary processor 1223, the auxiliary processor 1223 may be configured to use lower power than the main processor 1221 or to be specified for a designated function. The auxiliary processor 1223 may be implemented as separate from, or as part of the main processor 1221.

The auxiliary processor 1223 may control at least some of functions or states related to at least one component (e.g., the display module 1260, the sensor module 1276, or the communication module 1290) among the components of the electronic device 1201, instead of the main processor 1221 while the main processor 1221 is in an inactive (e.g., sleep) state, or together with the main processor 1221 while the main processor 1221 is in an active state (e.g., executing an application). According to an embodiment, the auxiliary processor 1223 (e.g., an ISP or a CP) may be implemented as part of another component (e.g., the camera module 1280 or the communication module 1290) functionally related to the auxiliary processor 123. According to an embodiment, the auxiliary processor 1223 (e.g., the neural processing unit) may include a hardware structure specified for AI model processing. The AI model may be generated via machine learning. Such learning may be performed, e.g., by the electronic device 1201 where the AI is performed or via a separate server (e.g., the server 1208). Learning algorithms may include, but are not limited to, e.g., supervised learning, unsupervised learning, semi-supervised learning, or reinforcement learning. The AI model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The AI model may, additionally or alternatively, include a software structure other than the hardware structure.

The memory 1230 may store various data used by at least one component (e.g., the processor 1220 or the sensor module 1276) of the electronic device 1201. The various data may include, for example, software (e.g., the program 1240) and input data or output data for a command related thereto. The memory 1230 may include the volatile memory 1232 or the non-volatile memory 1234.

The program 1240 may be stored in the memory 1230 as software, and may include, for example, an operating system (OS) 1242, middleware 1244, or an application 1246.

The input module 1250 may receive a command or data to be used by other component (e.g., the processor 1220) of the electronic device 1201, from the outside (e.g., a user) of the electronic device 1201. The input module 1250 may include, for example, a microphone, a mouse, a keyboard, keys (e.g., buttons), or a digital pen (e.g., a stylus pen).

The sound output module 1255 may output sound signals to the outside of the electronic device 1201. The sound output module 1255 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1260 may visually provide information to the outside (e.g., a user) of the electronic device 1201. The display 1260 may include, for example, a display, a hologram device, or a projector and control circuitry to control a corresponding one of the display, hologram device, and projector. According to an embodiment, the display 1260 may include a touch sensor configured to detect a touch, or a pressure sensor configured to measure the intensity of a force generated by the touch.

The audio module 1270 may convert a sound into an electrical signal and vice versa. According to an embodiment, the audio module 1270 may obtain the sound via the input module 1250, or output the sound via the sound output module 1255 or a headphone of an external electronic device (e.g., an electronic device 1202) directly (e.g., wiredly) or wirelessly coupled with the electronic device 1201.

The sensor module 1276 may detect an operational state (e.g., power or temperature) of the electronic device 1201 or an environmental state (e.g., a state of a user) external to the electronic device 101, and then generate an electrical signal or data value corresponding to the detected state. According to an embodiment, the sensor module 1276 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 1277 may support one or more specified protocols to be used for the electronic device 1201 to be coupled with the external electronic device (e.g., the electronic device 1202) directly (e.g., wiredly) or wirelessly. According to an embodiment, the interface 1277 may include, for example, a high definition multimedia interface (HDMI), a universal serial bus (USB) interface, a secure digital (SD) card interface, or an audio interface.

A connecting terminal 1278 may include a connector via which the electronic device 1201 may be physically connected with the external electronic device (e.g., the electronic device 1202). According to an embodiment, the connecting terminal 1278 may include, for example, a HDMI connector, a USB connector, a SD card connector, or an audio connector (e.g., a headphone connector).

The haptic module 1279 may convert an electrical signal into a mechanical stimulus (e.g., a vibration or motion) or electrical stimulus which may be recognized by a user via his tactile sensation or kinesthetic sensation. According to an embodiment, the haptic module 1279 may include, for example, a motor, a piezoelectric element, or an electric stimulator.

The camera module 1280 may capture a still image or moving images. According to an embodiment, the camera module 1280 may include one or more lenses, image sensors, image signal processors, or flashes.

The power management module 1288 may manage power supplied to the electronic device 1201. According to an embodiment, the power management module 1288 may be implemented as at least part of, for example, a PMIC.

The battery 1289 may supply power to at least one component of the electronic device 1201. According to an embodiment, the battery 1289 may include, for example, a primary cell which is not rechargeable, a secondary cell which is rechargeable, or a fuel cell.

The communication module 1290 may support establishing a direct (e.g., wired) communication channel or a wireless communication channel between the electronic device 1201 and the external electronic device (e.g., the electronic device 1202, the electronic device 1204, or the server 1208) and performing communication via the established communication channel. The communication module 1290 may include one or more CPs that are operable independently from the processor 1220 (e.g., the AP) and supports a direct (e.g., wired) communication or a wireless communication. According to an embodiment, the communication module 1290 may include a wireless communication module 1292 (e.g., a cellular communication module, a short-range wireless communication module, or a global navigation satellite system (GNSS) communication module) or a wired communication module 1294 (e.g., a local area network (LAN) communication module or a power line communication (PLC) module). A corresponding one of these communication modules may communicate with the external electronic device 1204 via a first network 1298 (e.g., a short-range communication network, such as Bluetooth™, wireless-fidelity (Wi-Fi) direct, or infrared data association (IrDA)) or a second network 1299 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1292 may identify or authenticate the electronic device 1201 in a communication network, such as the first network 1298 or the second network 1299, using subscriber information (e.g., international mobile subscriber identity (IMSI)) stored in the subscriber identification module 1296.

The wireless communication module 1292 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1292 may support a high-frequency band (e.g., the mmWave band) to achieve, e.g., a high data transmission rate. The wireless communication module 1292 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1292 may support various requirements specified in the electronic device 1201, an external electronic device (e.g., the electronic device 1204), or a network system (e.g., the second network 1299). According to an embodiment, the wireless communication module 1292 may support a peak data rate (e.g., 20Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 1297 may transmit or receive a signal or power to or from the outside (e.g., the external electronic device). According to an embodiment, the antenna module 1297 may include one antenna including a radiator formed of a conductor or conductive pattern formed on a substrate (e.g., a printed circuit board (PCB)). According to an embodiment, the antenna module 1297 may include a plurality of antennas (e.g., an antenna array). In this case, at least one antenna appropriate for a communication scheme used in a communication network, such as the first network 1298 or the second network 1299, may be selected from the plurality of antennas by, e.g., the communication module 1290. The signal or the power may then be transmitted or received between the communication module 1290 and the external electronic device via the selected at least one antenna. According to an embodiment, other parts (e.g., radio frequency integrated circuit (RFIC)) than the radiator may be further formed as part of the antenna module 1297.

According to various embodiments, the antenna module 1297 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 1201 and the external electronic device 1204 via the server 1208 coupled with the second network 1299. The external electronic devices 1202 or 104 each may be a device of the same or a different type from the electronic device 1201. According to an embodiment, all or some of operations to be executed at the electronic device 1201 may be executed at one or more of the external electronic devices 1202, 1204, or 1208. For example, if the electronic device 1201 should perform a function or a service automatically, or in response to a request from a user or another device, the electronic device 1201, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1201. The electronic device 1201 may provide the outcome, with or without further processing of the outcome, as at least part of a reply to the request. To that end, a cloud computing, distributed computing, mobile edge computing (MEC), or client-server computing technology may be used, for example. The electronic device 1201 may provide ultra low-latency services using, e.g., distributed computing or mobile edge computing. In an embodiment, the external electronic device 1204 may include an internet-of-things (IoT) device. The server 1208 may be an intelligent server using machine learning and/or a neural network. According to an embodiment, the external electronic device 1204 or the server 1208 may be included in the second network 1299. The electronic device 1201 may be applied to intelligent services (e.g., smart home, smart city, smart car, or healthcare) based on 5G communication technology or IoT-related technology.

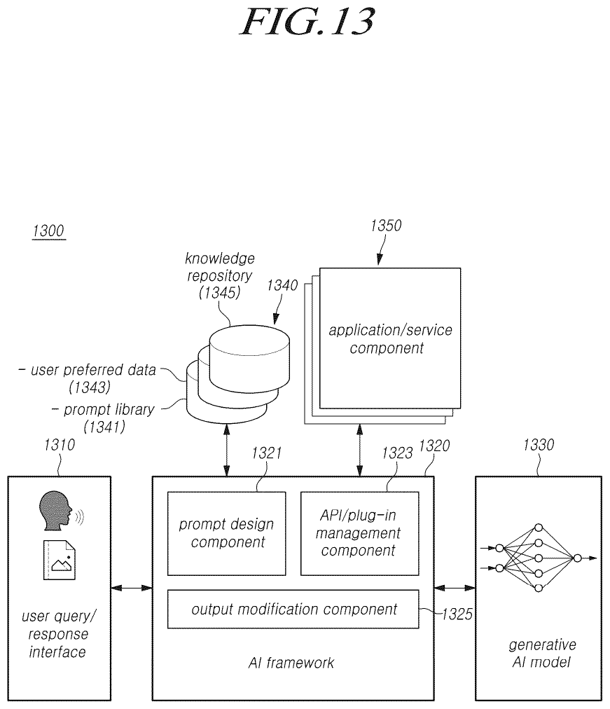

FIG. 13 is a block diagram illustrating an example configuration of an AI system 1300 capable of performing operations described in the disclosure according to one or more embodiment(s). The AI system 1300 may be a generative AI system but is referred to as an ‘AI system 1300’hereinafter.

Referring to FIG. 13, the AI system 1300 may include a user query/response interface (e.g., including interface circuitry) 1310 (e.g., the I/F 220 of FIG. 2) (hereinafter referred to as an ‘I/F 1310)’, an AI framework 1320, a generative AI model 1330, a database 1340, and/or an application/service component 1350.

The I/F 1310 may include various circuitry and receive an input (e.g., a user input or data obtained or generated by the electronic device (e.g., the electronic device 100 of FIG. 1 or the electronic device 1201 of FIG. 12) (hereinafter, referred to as an ‘electronic device 100’)). The data obtained or generated by the electronic device 100 may include image or video data generated using a processor (e.g., the processor 110 of FIG. 1 or the processor 1220 of FIG. 12), values received through a sensor or sensor hub (e.g., the external illuminance, the angle of the terminal, the temperature of the display (e.g., the display 140 of FIG. 1) or the electronic device 100, the size or extension/shrinkage information about the display 140, the photographed image of an image sensor (e.g., the image sensor 150 of FIG. 1). The user input may be in the form of natural language, touch coordinates or stylus coordinates, images and/or videos obtained through the touch panel included in the display 140, or a digitizer. Further, context information may also be transmitted when the user input is transmitted. The context information may include various additional pieces of information at the time of the user input. The additional information may include, e.g., application information currently used by the user or location information about the user. Further, the user input may be a combination of the above-described natural language, image, sound, and context information. Further, the user input may be in an unnatural form, such as selecting a menu. The I/F 1310 may provide a result by the AI system 1300 and/or a result of analyzing the input as an output to the user. The output may be in a natural language form or a specific content form. The output may be provided in the form of an action or the like requested by the user. The output may be provided in the form of a specific value designated by the user. The I/F 1310 may output the result of the generative AI system 1300 to the user. The output may be in a natural language form or a specific content form. The output may be provided in the form of an action or the like requested by the user.

The AI framework 1320 may receive the user's input and coordinate and control each component necessary to perform the user's intention based on the user's query. For example, the AI framework 1320 may include a prompt design component 1321, an API/plug-in management component 1323, or an output modification component (or refiner component) 1325.

The user input received by the I/F 1310 may be transmitted to the prompt design component 1321. The prompt design component 1321 may use the user input to generate a prompt (e.g., the prompt 250 of FIG. 2) suitable for being input to the generative AI model 1330 (e.g., the LLM, a large vision model (LVM), or a large multimodal model (LMM). The prompt design component 1321 may be an AI component that uses a machine learning algorithm or a neural network to develop a better prompt 250 over time. The prompt design component 1321 may generate a prompt 250 by accessing a knowledge component including user preference data, a prompt library, and a prompt example based on the user input, and may transfer the generated prompt 250 to the generative AI model 1330.

When transferring the user input as the input of the generative AI model 1330, the API/plug-in management component 1323 may perform a role of communicating with external information when there is a request for additional information. The API/plug-in management component 1323 establishes a channel capable of communicating with the outside of the AI interface through the API and allows access to various data sources (e.g., the knowledge repositors 1345) through the established channel. For example, the knowledge repository 1345 may store user preference data 1343 and/or prompt library 1341. When the application or service is required to perform an action of finally performing a user input rather than an intermediate result, the API/plug-in management component 1323 may request the corresponding action from the application/service component 1350 through the API. Information obtained from the outside may be used to generate the prompt 250 in the prompt design component 1321 along with the user input or may be transferred as an input to the generative AI model 1330.

The output modification component 1325 (which may also be referred to as a refiner component) may finely tune or reprocess the result output from the generative AI model 1330. The output modification component 1325 may verify, e.g., whether the content generated through the generative AI model 1330 is irrelevant, contains biased content, or contains harmful content. The output modification component 1325 may determine how much it matches the user's desired result and, if an additional process is required, proceed with the corresponding process. The output modification component 1325 may further configure hints for avoiding unwanted outputs and provide them to the user.

The generative AI model 1330 may generally refer, for example, to an AI neural network that generates a new type of data depending on user input information. The generative AI model 1330 may include a model for generating an image and/or a model for generating a language. The model for generating the image may include, e.g., a generative advertising network (GAN) or a variational auto encoder (VAE). The model for generating the image may be, e.g., a diffusion-based AI model using a VAE and a transformer structure. The model for generating the language may be a model trained to output the most statistically appropriate output value based on an input value. Representative examples include models such as CHAT-GPT 3 and CHAT-GPT 4. There is also an LMM as an AI model 1330 that may recognize various types of data inputs such as text, images, voice, and videos and generate new data corresponding thereto.

The disclosures are not limited to the foregoing, and other unmentioned aspects would be apparent to one skilled in the art.

According to an example embodiment, an electronic device may include: memory including one or more storage media storing instructions; at least one processor, comprising processing circuitry, at least one processor, individually and/or collectively, configured to execute the instructions and to cause the electronic device to perform at least one operation comprising: outputting first tokens for each first model in response to an input of a prompt from a plurality of first models ; outputting second tokens for each first model using the first tokens for each first model as an input from a target model ; and determining a target model to be used for speculative decoding among the plurality of first models based on a similarity between a first probability distribution of the first tokens for each first model and a second probability distribution of the second tokens for each first model.

According to an example embodiment, the at least one operation may include inputting the prompt to the target model and the plurality of first models.

According to an example embodiment, the at least one operation may include outputting a start token in response to the input of the prompt from the target model.

According to an example embodiment, the at least one operation may include outputting the first tokens for each first model in response to an input of the start token.

According to an example embodiment, the at least one operation may include, based on the target model being determined, performing the speculative decoding by the target model and the target model.

According to an example embodiment, the first tokens for each first model may be similar to the second token for each first model.

According to an example embodiment, the at least one operation may include determining a first probability distribution by quantifying probability values of the first tokens for each first model being generated.

According to an example embodiment, the at least one operation may include determining a second probability distribution by quantifying probability values of the second token for each first model being generated.

According to an example embodiment, the at least one operation may include determining the target model based on a size of the plurality of first models, the size is determined by a number of parameters in a corresponding first model.

According to an example embodiment, the at least one operation may include determining the target model based on state information about the electronic device. The state information may include information indicating the heat generation state or battery charging state.

According to an example embodiment, a size of the target model may be configured to be larger than a size of the plurality of first models.

According to an example embodiment, the size of the target model is determined by a number of parameters in the target model.

According to an example embodiment, a size of each first model is determined by a number of parameters in a corresponding first model.

According to an example embodiment, the size of the plurality of first models may be configured to differ from each other.

According to an example embodiment, the at least one operation may include, in response to first tokens for each first model output from a specific first model included in the plurality of first models not being identical second tokens for each first model output from the target model, excluding the specific first model from candidates that may be determined as the target model.

According to an example embodiment, there may be provided a non-transitory computer-readable storage medium storing at least one instruction. The at least one instruction, when executed by at least one processor, comprising processing circuitry, individually and/or collectively, of an electronic device, may cause the electronic device to perform at least one operation comprising: outputting first tokens for each first model in response to an input of a prompt from a plurality of first models; outputting second tokens for each first model using the first tokens for each first model as an input from a target model; and determining a target model to be used for speculative decoding among the plurality of first models based on a similarity between a first probability distribution of the first tokens for each first model and a second probability distribution of the second tokens for each first model.

According to an example embodiment, the at least one operation may include inputting the prompt to the target model and the plurality of first models.

According to an example embodiment, the at least one operation may include outputting a start token in response to the input of the prompt from the target model.

According to an example embodiment, the at least one operation may include outputting first tokens for each first model performed in response to an input of the start token.

According to an example embodiment, the at least one operation may include, based on the target model being determined, performing the speculative decoding by the target model and the target model.

According to an example embodiment, the first tokens for each first model may be similar to the second token for each first model.

According to an example embodiment, the at least one operation may include determining a first probability distribution by quantifying probability values of the first tokens for each first model being generated.

According to an example embodiment, the at least one operation may include determining a second probability distribution by quantifying probability values of the second token for each first model being generated.

According to an example embodiment, the at least one operation may include determining the target model based on a size of the plurality of first models, the size is determined by a number of parameters in a corresponding first model.

According to an example embodiment, the at least one operation may include determining the target model based on state information about the electronic device. The state information may include information indicating the heat generation state or battery charging state.

According to an example embodiment, the size of the target model may be configured to be larger than the sizes of the plurality of first models, the size of the target model is determined by a number of parameters in the target model, a size of each first model is determined by a number of parameters in a corresponding first model, and the sizes of the plurality of first models may be configured to be different from each other.

According to an example embodiment, the at least one operation may include, in response to first tokens for each first model output from a specific first model included in the plurality of first models not being identical second tokens for each first model output from the target model, excluding the specific first model from candidates that may be determined as the target model.

According to an example embodiment, there may be provided a method for executing a generative AI model in an electronic device. The method may comprise: outputting first tokens for each first model in response to an input of a prompt from a plurality of first models; outputting second tokens for each first model using the first tokens for each first model as an input from a target model; and determining a target model to be used for speculative decoding among the plurality of first models based on a similarity between a first probability distribution of the first tokens for each first model and a second probability distribution of the second tokens for each first model.

According to an example embodiment, the method may comprise inputting the prompt to the target model and the plurality of first models.

According to an example embodiment, the method may comprise outputting a start token in response to the input of the prompt from the target model.

According to an example embodiment, the method may comprise outputting first tokens for each first model performed in response to an input of the start token.

According to an example embodiment, the method may comprise, based on the target model being determined, performing the speculative decoding by the target model and the target model.

According to an example embodiment, the first tokens for each first model may be similar to the second token for each first model.

According to an example embodiment, the method may comprise determining a first probability distribution by quantifying probability values of the first tokens for each first model being generated.

According to an example embodiment, the method may comprise determining a second probability distribution by quantifying probability values of the second token for each first model being generated.

According to an example embodiment, the method may comprise determining the target model based on a size of the plurality of first models, the size is determined by a number of parameters in a corresponding first model.

According to an example embodiment, the method may comprise determining the target model based on state information about the electronic device. The state information may include information indicating the heat generation state or battery charging state.

According to an example embodiment, the size of the target model may be configured to be larger than the sizes of the plurality of first models, the size of the target model is determined by a number of parameters in the target model, a size of each first model is determined by a number of parameters in a corresponding first model, and the sizes of the plurality of first models may be configured to be different from each other.

According to an example embodiment, the method may comprise, in response to first tokens for each first model output from a specific first model included in the plurality of first models being not identical second tokens for each first model output from the target model, excluding the specific first model from candidates that may be determined as the target model.

According to an example embodiment, the electronic device may comprise at least one processor, comprising processing circuitry. The electronic device may comprise a memory storing instructions. At least one processor, individually and/or collectively, may be configured to execute the instructions and to cause the electronic device to perform at least one operation comprising: obtaining an AI model including a target model and a first draft model and a second draft model having a smaller size than the target model; obtaining input tokens for the AI model based on an input; identifying first output tokens of the first draft model for the input tokens and first probabilities that the first output tokens, respectively, are to be output from the first draft model; identifying second output tokens of the target model for the first output tokens and second probabilities that the second output tokens, respectively, are to be output from the target model; identifying third output tokens of the second draft model for the input tokens and third probabilities that the third output tokens, respectively, are to be output from the second draft model; identifying fourth output tokens of the target model for the third output tokens and fourth probabilities that the fourth output tokens, respectively, are to be output from the target model; selecting one of the first draft model and the second draft model at least partially based on the first probabilities, the second probabilities, the third probabilities, and the fourth probabilities; and providing an output for the input at least partially based on the selected one draft model.

According to an example embodiment, the at least one operation may include, based on a difference between at least some of the first probabilities and at least some of the corresponding second probabilities being less than a difference between at least some of the third probabilities and at least some of the corresponding fourth probabilities, selecting the first draft model of the first draft model and the second draft model.

According to an example embodiment, the at least one operation may include, based on a difference between at least some of the first probabilities and at least some of the corresponding second probabilities being greater than a difference between at least some of the third probabilities and at least some of the corresponding fourth probabilities, selecting the second draft model of the first draft model and the second draft model.

According to an example embodiment, the at least one operation may include, based on the first output tokens and the second output tokens including the same output token, selecting the one draft model based on a difference between a first probability that the same output token is to be output from the first draft model and a second probability that the same output token is to be output from the target model.

According to an example embodiment, the at least one operation may include, based on the first output tokens and the second output tokens including the same output token, selecting the one draft model based on a square of a difference between the first probability and the second probability.

According to an example embodiment, the at least one operation may include, based on a different output token not included in the first output tokens being included in the second output tokens, selecting the one draft model based on a probability that the different output token is to be output from the target model.

According to an example embodiment, the at least one operation may include, based on a different output token not included in the first output tokens being included in the second output tokens, selecting the one draft model based on a square of a probability that the different output token is to be output from the target model.

According to an example embodiment, the at least one operation may include identifying the first output tokens by repeating the operation of using the output of the first draft model for the input tokens as an input to the first draft model multiple times.

According to an example embodiment, the at least one operation may include identifying the third output tokens by repeating the operation of using the output of the second draft model for the input tokens as an input to the second draft model multiple times.

According to an example embodiment, the at least one operation may include changing at least some of tokens to be output from the selected one draft model into at least some of the second output tokens based on a difference between the at least some of the first probabilities and the at least some of the second probabilities.

According to an example embodiment, the at least one operation may include, based on a difference between at least some of the first probabilities and at least some of the corresponding second probabilities and a difference between at least some of the third probabilities and at least some of the corresponding fourth probabilities being identical or similar, selecting the one draft model further based on the number of same tokens included in the first output tokens and the second output tokens and the number of same tokens included in the third output tokens and the fourth output tokens.

According to an example embodiment, the first draft model may have a different size from the second draft model.

According to an example embodiment, the at least one operation may include, based on a difference between at least some of the first probabilities and at least some of the corresponding second probabilities and a difference between at least some of the third probabilities and at least some of the corresponding fourth probabilities being identical or similar, selecting the one draft model further based on the sizes of the first draft model and the second draft model.

According to an example embodiment, the at least one operation may include, based on a difference between at least some of the first probabilities and at least some of the corresponding second probabilities and a difference between at least some of the third probabilities and at least some of the corresponding fourth probabilities being identical or similar, selecting the one draft model further based on state information about the electronic device.

According to an example embodiment, the state information about the electronic device may include the heat generation state or battery charging state of at least part of the electronic device.

According to an example embodiment, the at least one operation may include generating the input tokens based on the user input and the target model.

According to an example embodiment, the operation speed of the target model may be slower than the operation speed of the first draft model and the operation speed of the second draft model.

According to an example embodiment, the number of parameters of the target model may be greater than the number of parameters of the first draft model and the number of parameters of the second draft model.

According to an example embodiment, the complexity of the target model may be greater than the complexity of the first draft model and the complexity of the second draft model.

According to an example embodiment, the quantization of the first draft model and the second draft model may be applied to the first draft model and the second draft model more strongly than the target model.

According to an example embodiment, the AI model may include a LLM.

An embodiment of the disclosure and terms used therein are not intended to limit the technical features described in the disclosure to specific embodiments, and should be understood to include various modifications, equivalents, or substitutes of the various embodiments. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used herein, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment as set forth herein may be implemented as software including one or more instructions that are stored in a storage medium (e.g., the memory 230) readable by a machine (e.g., the electronic device 100). For example, a processor (e.g., the CPU 211, the NPU 213, or the GPU 215) of the machine (e.g., the electronic device 100) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device, comprising:
memory including one or more storage media storing instructions; and
at least one processor, comprising processing circuitry, wherein at least one processor, individually and/or collectively, is configured to execute the instructions and to cause the electronic device to perform at least one operation, comprising:
outputting first tokens for each first model in response to an input of a prompt from a plurality of first models;
outputting second tokens for each first model using the first tokens for each first model as an input from a second model; and
determining a target model to be used for speculative decoding among the plurality of first models based on a similarity between a first probability distribution of the first tokens for each first model and a second probability distribution of the second tokens for each first model.

2. The electronic device of claim 1, wherein at least one processor, individually or collectively, is configured to cause the electronic device to:
input the prompt to the second model and the plurality of first models;
output a start token in response to the input of the prompt from the second model; and
output the first tokens for each first model in response to an input of the start token.

3. The electronic device of claim 1, wherein at least one processor, individually or collectively, is configured to cause the electronic device to, based on the target model being determined, perform the speculative decoding by the second model and the target model.

4. The electronic device of claim 1, wherein the first tokens for each first model are similar to the second tokens for each first model.

5. The electronic device of claim 1, wherein at least one processor, individually and/or collectively, is configured to cause the electronic device to:
determine a first probability distribution by quantifying probability values of the first tokens for each first model being generated; and
determine a second probability distribution by quantifying probability values of the second tokens for each first model being generated.

6. The electronic device of claim 1, wherein at least one processor, individually and/or collectively, is configured to cause the electronic device to determine the target model based on a size of the plurality of first models, the size is determined by a number of parameters in a corresponding model.

7. The electronic device of claim 1, wherein at least one processor, individually and/or collectively, is configured to cause the electronic device to determine the target model based on state information about the electronic device, the state information including information indicating a heat generation state or a battery charging state.

8. The electronic device of claim 1, wherein a size of the second model is configured to be greater than a size of the plurality of first models, and
wherein the size of the second model is determined by a number of parameters in the second model, a size of each first model is determined by a number of parameters in a corresponding model, and sizes of the plurality of first models are configured to differ from each other.

9. The electronic device of claim 1, wherein at least one processor, individually and/or collectively, is configured to cause the electronic device to, in response to first tokens for each first model output from a specific model included in the plurality of first models not being identical to second tokens for each first model output from the second model, exclude the specific model from candidates that may be determined as the target model.

10. A method performed by an electronic device, the method comprising:
outputting first tokens for each first model in response to an input of a prompt from a plurality of first models;
outputting second tokens for each first model using the first tokens for each first model as an input from a second model; and
determining a target model to be used for speculative decoding among the plurality of first models based on a similarity between a first probability distribution of the first tokens for each first model and a second probability distribution of the second tokens for each first model.

11. The method of claim 10, further comprising:
inputting the prompt to the second model and the plurality of first models;
outputting a start token in response to the input of the prompt from the second model; and
outputting the first tokens for each first model in response to an input of the start token.

12. The method of claim 10, further comprising, based on the target model being determined, performing the speculative decoding by the second model and the target model.

13. The method of claim 10, wherein the first tokens for each first model are similar to the second tokens for each first model.

14. The method of claim 10, further comprising:
determining a first probability distribution by quantifying probability values of the first tokens for each first model being generated; and
determining a second probability distribution by quantifying probability values of the second tokens for each first model being generated.

15. The method of claim 10, further comprising determining the target model based on a size of the plurality of first models, the size is determined by a number of parameters in a corresponding model.

16. The method of claim 10, further comprising determining the target model based on state information about the electronic device, the state information including information indicating a heat generation state or a battery charging state.

17. The method of claim 10, wherein a size of the second model is configured to be greater than a size of the plurality of first models, and
wherein the size of the second model is determined by a number of parameters in the second model, a size of each first model is determined by a number of parameters in a corresponding model, and sizes of the plurality of first models are configured to differ from each other.

18. The method of claim 10, further comprising, in response to first tokens for each first model output from a specific model included in the plurality of first models not being identical to second tokens for each first model output from the second model, excluding the specific model from candidates that may be determined as the target model.

19. A non-transitory computer-readable storage medium storing at least one computer-readable instruction, wherein the at least one instruction, when executed at least one processor, comprising processing circuitry, individually and/or collectively, of an electronic device, causes the electronic device to perform at least one operation, and wherein the at least one operation comprises:
outputting first tokens for each first model in response to an input of a prompt from a plurality of first models;
outputting second tokens for each first model using the first tokens for each first model as an input from a second model; and
determining a target model to be used for speculative decoding among the plurality of first models based on a similarity between a first probability distribution of the first tokens for each first model and a second probability distribution of the second tokens for each first model.

20. A non-transitory computer-readable storage medium, storing instructions comprising at least one operation which, when executed by at least one processor, comprising processing circuitry, individually and/or collectively, of an electronic device, cause the electronic device to perform the operations of claim 2.
